(19) United States
(12) Patent Application Publication
(10) Pub. No.: US 2019/0082176 A1
(43) Pub. Date: Mar. 14, 2019

(54) NON-LOCAL BILATERAL FILTER

(71) Applicant: QUALCOMM Incorporated, San Diego, CA (US)

(72) Inventors: Li Zhang, San Diego, CA (US); Xin Zhao, Santa Clara, CA (US); Wei-Jung Chien, San Diego, CA (US); Marta Karczewicz, San Diego, CA (US)

(21) Appl. No.: 16/126,946

(22) Filed: Sep. 10, 2018

Related U.S. Application Data
(60) Provisional application No. 62/556,614, filed on Sep. 11, 2017.

(51) Int. Cl. H04N 19/117; G06T 5/50; G06T 5/00

(52) U.S. Cl. CPC H04N 19/117; G06T 5/50; G06T 2207/20192; G06T 2207/20028; G06T 5/002

(57) ABSTRACT

Techniques are described for bilateral filtering in video coding process. The techniques utilize non-local bilateral filtering techniques. The non-local bilateral filtering techniques may include determining sample value differences between a first window that includes a current sample to be filtered and one or more additional samples, and a second window that includes a neighboring sample with which the current sample is being filtered and one or more additional samples. The techniques utilize the sample value differences to determine a weighting parameter for bilateral filtering.

This application claims the benefit of U.S. Provisional Application No. 62/556,614, filed Sep. 11, 2017, the entire content of which is hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the ITU-T H.265, High Efficiency Video Coding (HEVC), standard, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques related to non-local, division-free bilateral filtering in video coding. As described in more detail, a video coder (e.g., video encoder or video decoder) may determine differences in sample values (e.g., intensity values of samples) between a first window that includes a current sample to be filtered and one or more additional samples, and a second window that includes a neighboring sample to the current sample and one or more additional samples. Based on the differences, the video coder determines a weighting parameter that is applied to filter the current sample. By relying on sample values of samples within windows, rather than the sample values of only the current and neighboring sample, the video coder may compensate for outliers (e.g., sudden jumps) between the current and neighboring sample, resulting in more optimal weighting parameters.

In one example, this disclosure describes a method of filtering video data, the method comprising performing non-local bilateral filtering (NL-Bil) to filter a current sample and generate a filtered current sample of a block of the video data, wherein performing the NL-Bil comprises determining a difference between sample values of a first window covering the current sample and a second window covering a neighboring sample, wherein each of the first and second windows includes two or more samples, determining a weighting parameter associated with the neighboring sample based on the determined difference, and filtering the current sample based on the determined weighting parameter to generate the filtered current sample, and outputting the filtered current sample.

In one example, this disclosure describes a device for filtering video data, the device comprising video data memory configured to store sample values for a current sample and a neighboring sample, and a video coder comprising at least one of fixed-function or programmable circuitry and coupled to the video data memory. The video coder is configured to perform non-local bilateral filtering (NL-Bil) to filter a current sample and generate a filtered current sample of a block of the video data, wherein to perform the NL-Bil, the video coder is configured to determine a difference between sample values of a first window covering the current sample and a second window covering a neighboring sample, wherein each of the first and second windows includes two or more samples, determine a weighting parameter associated with the neighboring sample based on the determined difference, and filter the current sample based on the determined weighting parameter to generate the filtered current sample, and output the filtered current sample.

In one example, this disclosure describes a device for filtering video data, the device comprising means for performing non-local bilateral filtering (NL-Bil) to filter a current sample and generate a filtered current sample of a block of the video data, wherein the means for performing the NL-Bil comprises means for determining a difference between sample values of a first window covering the current sample and a second window covering a neighboring sample, wherein each of the first and second windows includes two or more samples, means for determining a weighting parameter associated with the neighboring sample based on the determined difference, and means for filtering the current sample based on the determined weighting parameter to generate the filtered current sample, and means for outputting the filtered current sample.

In one example, this disclosure describes a computer-readable storage medium storing instructions that when executed cause one or more processors of a device for filtering video data to perform non-local bilateral filtering (NL-Bil) to filter a current sample and generate a filtered current sample of a block of the video data, wherein the instructions that cause the one or more processors to perform the NL-Bil comprise instructions that cause the one or more processors to determine a difference between sample values of a first window covering the current sample and a second window covering a neighboring sample, wherein each of the first and second windows includes two or more samples, determine a weighting parameter associated with the neighboring sample based on the determined difference, and filter the current sample based on the determined weighting parameter to generate the filtered current sample, and output the filtered current sample.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram illustrating an example video encoding and decoding system that may utilize the techniques described in this disclosure.

FIG. 2A shows an example of coding tree unit (CTU)-to-coding unit (CU) partitioning in HEVC.

FIG. 2B shows the corresponding quadtree representation of FIG. 2A.

FIG. 3 is a flowchart illustrating an example operation of video decoding.

FIGS. 4A-4D show four 1-D directional patterns for edge offset (EO) sample classification.

FIG. 5 shows an example of one sample and its neighboring four samples utilized in a bilateral filtering process.

FIG. 6 shows another example of one sample and its neighboring four samples utilized in a bilateral filtering process.

FIG. 7 shows an example of one sample and its neighboring samples utilized in division-free bilateral filtering (DFBil).

FIG. 8 is an example of samples in a window covering a current sample (K=5, L=3).

FIG. 9 is an example of a template for a current sample (P0) and its four neighbors used in non-local bilateral filter.

FIG. 10 is an example of windows for filtering with P0,m and P2,m (m=0.8).

FIG. 11 is a block diagram illustrating an example video encoder that may implement the techniques described in this disclosure.

FIG. 12 is a block diagram illustrating an example video decoder that may implement the techniques described in this disclosure.

FIG. 13 shows an example implementation of a filter unit for performing the techniques of this disclosure.

FIG. 14 is a flowchart illustrating one or more example methods of filtering, in accordance with one or more example techniques of this disclosure.

### DETAILED DESCRIPTION

This disclosure describes techniques related to a filtering method which may be used in a post-processing stage, as part of in-loop coding, or in the prediction stage of a video encoder and/or decoder. The techniques of this disclosure may be implemented into existing video codecs, such as HEVC (High Efficiency Video Coding) codecs or be an efficient coding tool for a future video coding standard, such as the H.266 standard presently under development, referred to as versatile video coding (VVC) and the subject of Joint Exploration Model 7 (JEM 7), by the Joint Video Exploration Team (JVET). The reference software for JEM 7 can be downloaded from https://jvet.hhi.fraunhofer.de/syn/syn_HMJEMSoftware/tags/HM-16.6-JEM-7.0/. An algorithm description of Joint Exploration Test Model 6 (JEM6) may also be referred to as JVET-G1011.

As part of encoding or decoding, a video coder (e.g., video encoder or video decoder) performs bilateral filtering, as a way to smooth out image content within a block of video data. As one example, a video encoder performs the bilateral filtering as part of a reconstruction process that the video encoder performs for generating reference pictures. A video decoder performs the bilateral filtering as part of reconstructing the block.

Some example techniques of bilateral filtering include determining a difference between a current sample of a video block being filtered and a neighboring sample, and determining a weighting parameter for the filtering based on the difference. This disclosure describes example techniques to perform non-local bilateral filtering. In non-local bilateral filtering, rather than determining a difference between only a current sample and a neighboring sample (which would be local bilateral filtering), the video coder determines a difference between samples within a first window and samples within a second window. In some examples, the first window and the second window overlap in samples, and in some examples, the first window and the second window do not overlap in samples. In one or more examples, the first window may include the current sample being filtered and one or more additional samples, and the second window may include the neighboring sample and one or more additional samples. In some examples, the additional samples may be samples outside the current block that includes the current sample, or may be limited to samples inside the current block that includes the current sample.

With the non-local bilateral filtering techniques described in this disclosure, the weighting parameters used for the filtering are determined based on differences between a plurality of samples, which tends to provide better smoothing of pixels as compared to local bilateral filtering. For example, by using the plurality of samples, the weighting parameters may be better representative of how a current sample should be filtered as compared to cases where only the current sample and a neighboring sample are used to determine the weighting parameter. For instance, there may be a sudden shift in the sample values between the current sample and the neighboring sample; however, this sudden shift in sample values may be an outlier and other samples neighboring the current sample and the neighboring sample may be more uniform.

With the example techniques described in this disclosure, there may be technical advantages that improve the operation of the video coding process. For example, the image content that the video decoder reconstructs may be of a higher quality (e.g., with fewer artifacts) as compared to image content generated using other bilateral filtering techniques.

Moreover, in some examples, the techniques described in this disclosure may be performed such that non-local bilateral filtering is possible without the need to perform a division. Hence, the example techniques may be considered as non-local division-free bilateral filtering. For instance, it may be possible to replace the division operation with a multiplication and shift operation. Processing circuity (e.g., fixed-function or programmable circuitry) of the video encoder and video decoder may require multiple clock cycles to perform the division operation between two numbers. However, multiplication and shift operations require substantially fewer clock cycles. Therefore, in one or more examples, the non-local bilateral filtering techniques may further improve operation of the video encoder and video decoder by performing non-local bilateral filtering that promotes processing efficiency.

The example techniques are not limited to requiring that non-local bilateral filtering be performed in such a way that the video encoder and video decoder do not perform division. Rather, it may be possible, using the example techniques to configure the video encoder and video decoder to perform non-local division-free bilateral filtering.

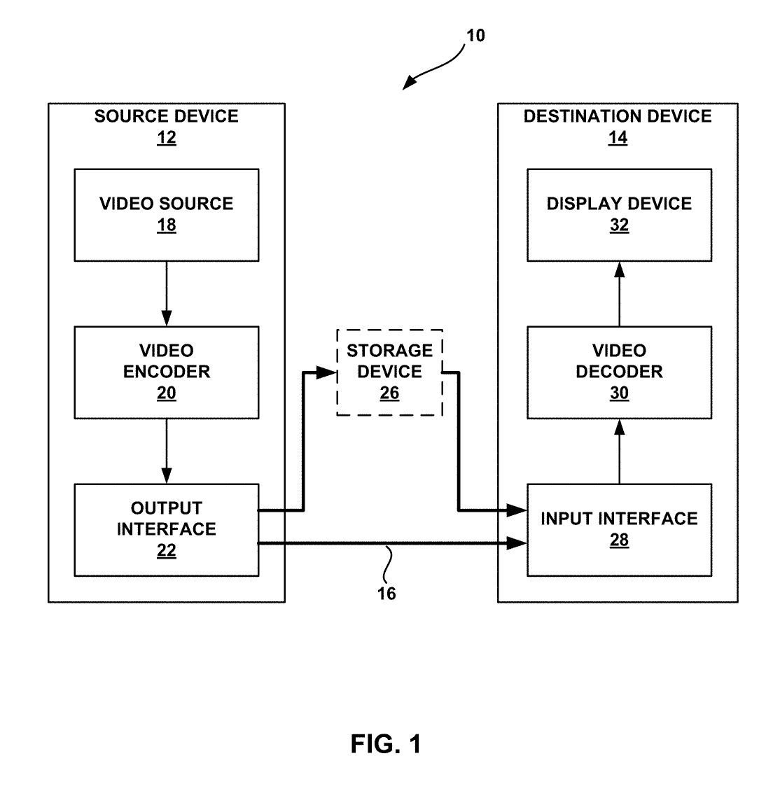

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard and may conform to the HEVC Test Model (HM). Video encoder 20 and video decoder 30 may additionally operate according to an HEVC extension, such as the range extension, the multiview extension (MV-HEVC), or the scalable extension (SHVC) which have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). HEVC is published as Recommendation ITU-T H.265, Series H: Audiovisual and Multimedia Systems, Infrastructure of audiovisual services—Coding of moving video, High efficiency video coding, December 2016.

Video encoder 20 and video decoder 30 may also operate according to other proprietary or industry standards, such as the ITU-T H.264 standard, alternatively referred to as ISO/IEC MPEG-4, Part 10, Advanced Video Coding (AVC), or extensions of such standards, such as the Scalable Video Coding (SVC) and Multi-view Video Coding (MVC) extensions. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, and ISO/IEC MPEG-4 Visual.

Techniques of this disclosure may utilize HEVC terminology for ease of explanation. It should not be assumed, however, that the techniques of this disclosure are limited to HEVC, and in fact, it is explicitly contemplated that the techniques of this disclosure may be implemented in successor standards to HEVC and its extensions, such as the H.266 video coding standard, also called versatile video coding (VVC).

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

ITU-T VCEG (Q6/16) and ISO/IEC MPEG (JTC 1/SC 29/WG 11) are now studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (WET) to evaluate compression technology designs proposed by their experts in this area for upcoming video coding standard H.266, also referred to as versatile video coding (VVC). The JVET first met during 19-21 Oct. 2015. One version of applicable reference software, i.e., Joint Exploration Model 7 (JEM 7) can be downloaded from: https://jvet.hhi.fraunhofer.de/svn/svn_HMJEMSoftware/tags/HM-16.6-JEM-7.0/. An algorithm description of Joint Exploration Test Model 6 (JEM6) may also be referred to as JVET-G1011.

In HEVC and other video coding specifications, a video sequence typically includes a series of pictures. Pictures may also be referred to as “frames.” In one example approach, a picture may include three sample arrays, denoted SL, Scb, and Scr. In such an example approach, SL is a two-dimensional array (i.e., a block) of luma samples. Scb is a two-dimensional array of Cb chrominance samples. Scr is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In monochrome pictures or pictures having three separate color planes, a CTU may comprise a single coding tree block and syntax structures used to code the samples of the coding tree block. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in a raster scan order.

To generate a coded CTU, video encoder 20 may recursively perform quad-tree partitioning on the coding tree blocks of a CTU to divide the coding tree blocks into coding blocks, hence the name “coding tree units.” A coding block may be an N×N block of samples. A CU may comprise a coding block of luma samples and two corresponding coding blocks of chroma samples of a picture that has a luma sample array, a Cb sample array, and a Cr sample array, and syntax structures used to code the samples of the coding blocks. In monochrome pictures or pictures having three separate color planes, a CU may comprise a single coding block and syntax structures used to code the samples of the coding block.

Video encoder 20 may partition a coding block of a CU into one or more prediction blocks. A prediction block is a rectangular (i.e., square or non-square) block of samples on which the same prediction is applied. A prediction unit (PU) of a CU may comprise a prediction block of luma samples, two corresponding prediction blocks of chroma samples, and syntax structures used to predict the prediction blocks. In monochrome pictures or pictures having three separate color planes, a PU may comprise a single prediction block and syntax structures used to predict the prediction block. Video encoder 20 may generate predictive luma, Cb, and Cr blocks for luma, Cb, and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU. If video encoder 20 uses inter prediction to generate the predictive blocks of a PU, video encoder 20 may generate the predictive blocks of the PU based on decoded samples of one or more pictures other than the picture associated with the PU.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb, and Cr residual blocks of a CU into one or more luma, Cb, and Cr transform blocks. A transform block is a rectangular (e.g., square or non-square) block of samples on which the same transform is applied. A transform unit (TU) of a CU may comprise a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

The above block structure with CTUs, CUs, PUs, and TUs generally describes the block structure used in HEVC. Other video coding standards, however, may use different block structures. As one example, although HEVC allows PUs and TUs to have different sizes or shapes, other video coding standards may require predictive blocks and transform blocks to have a same size. The techniques of this disclosure are not limited to the block structure of HEVC and may be compatible with other block structures.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encode syntax elements indicating the quantized transform coefficients. For example, video encoder 20 may perform Context-Adaptive Binary Arithmetic Coding (CABAC) on the syntax elements indicating the quantized transform coefficients.

Video encoder 20 may output a bitstream that includes a sequence of bits that forms a representation of coded pictures and associated data. The bitstream may comprise a sequence of Network Abstraction Layer (NAL) units. A NAL unit is a syntax structure containing an indication of the type of data in the NAL unit and bytes containing that data in the form of a raw byte sequence payload (RB SP) interspersed as necessary with emulation prevention bits. Each of the NAL units includes a NAL unit header and encapsulates a RBSP. The NAL unit header may include a syntax element that indicates a NAL unit type code. The NAL unit type code specified by the NAL unit header of a NAL unit indicates the type of the NAL unit. A RB SP may be a syntax structure containing an integer number of bytes that is encapsulated within a NAL unit. In some instances, an RB SP includes zero bits.

Different types of NAL units may encapsulate different types of RBSPs. For example, a first type of NAL unit may encapsulate an RBSP for a PPS, a second type of NAL unit may encapsulate an RBSP for a coded slice, a third type of NAL unit may encapsulate an RBSP for SEI messages, and so on. NAL units that encapsulate RBSPs for video coding data (as opposed to RBSPs for parameter sets and SEI messages) may be referred to as VCL NAL units.

Video decoder 30 may receive a bitstream generated by video encoder 20. In addition, video decoder 30 may parse the bitstream to obtain syntax elements from the bitstream. Video decoder 30 may reconstruct the pictures of the video data based at least in part on the syntax elements obtained from the bitstream. The process to reconstruct the video data may be generally reciprocal to the process performed by video encoder 20. In addition, video decoder 30 may inverse quantize coefficient blocks associated with TUs of a current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive blocks for PUs of the current CU to corresponding samples of the transform blocks of the TUs of the current CU. By reconstructing the coding blocks for each CU of a picture, video decoder 30 may reconstruct the picture.

As described in more detail, video encoder 20 and video decoder 30 may be configured to perform non-local bilateral filtering techniques described in this disclosure. For instance, for samples of a current block being encoded or decoded, video encoder 20 and video decoder 30 may determine a first window that includes a plurality of samples that encompass the sample being filtered and a second window that includes a plurality of samples that encompass a neighboring sample of the current sample. Video encoder 20 and video decoder 30 may determine a difference between sample values in the two windows (e.g., difference between sample values of corresponding samples located in the same relative locations in respective windows). Based on the differences between the sample values, video encoder 20 and video decoder 30 may determine weighting parameters that are to be applied as part of the bilateral filtering.

Aspects of HEVC and JEM techniques will now be discussed, including one or more example techniques described in this disclosure. The following is a description of the quad-tree structure, followed by the in-loop filters employed by HEVC. The following is a review of some of the above description of the HEVC techniques, HEVC utilizes a quadtree structure for partitioning blocks. In HEVC, the largest coding unit in a slice is called a coding tree block (CTB) or coding tree unit (CTU). A CTB contains a quad-tree the nodes of which are coding units. The blocks specified as luma and chroma CTBs can be directly used as CBs or can be further partitioned into multiple CBs. Partitioning is achieved using tree structures. The tree partitioning in HEVC is generally applied simultaneously to both luma and chroma, although exceptions apply when certain minimum sizes are reached for chroma.

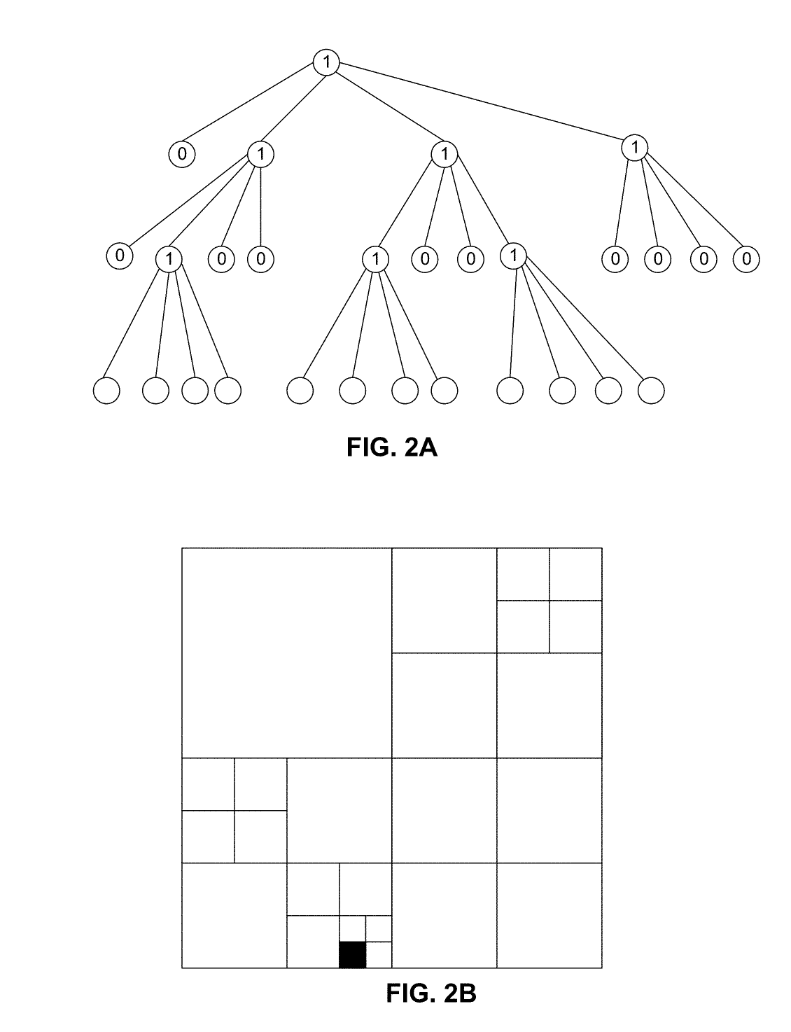

The CTU contains a quadtree syntax that allows for splitting the CBs to a selected appropriate size based on the signal characteristics of the region that is covered by the CTB. The quadtree splitting process can be iterated until the size for a luma CB reaches a minimum allowed luma CB size that is selected by the encoder (e.g., video encoder 20) using syntax in the SPS and is always 8×8 or larger (in units of luma samples). An example of splitting one CTU into multiple CBs is depicted in FIGS. 2A and 2B.

The boundaries of the picture are defined in units of the minimum allowed luma CB size. As a result, at the right and bottom edges of the picture, some CTUs may cover regions that are partly outside the boundaries of the picture. This condition is detected by the decoder (e.g., video decoder 30), and the CTU quadtree is implicitly split as necessary to reduce the CB size to the point where the entire CB fits into the picture.

FIG. 2A shows an example of CTU-to-CU partitioning in HEVC, and FIG. 2B shows the corresponding quadtree representation. Aspects of quadtree partitioning are described in more detail in G. J. Sullivan; J.-R. Ohm; W.-J. Han; T. Wiegand (December 2012). “Overview of the High Efficiency Video Coding (HEVC) Standard”. IEEE Transactions on Circuits and Systems for Video Technology (IEEE) 22 (12), December 2012. Note that no signaling is required when the leaf nodes correspond to 8×8 CUs.

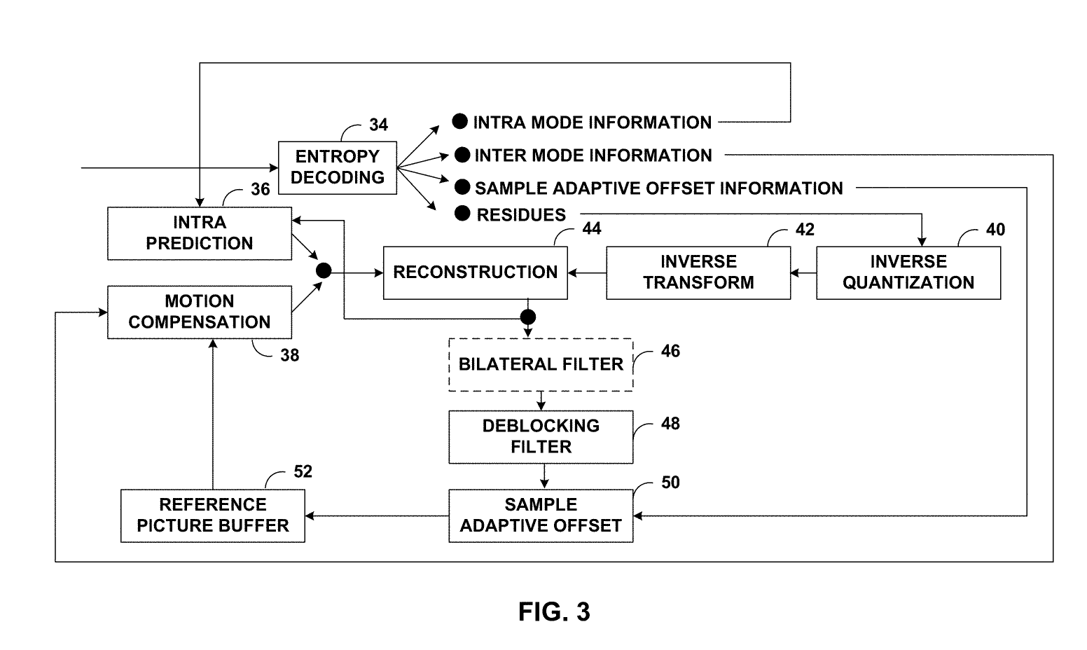

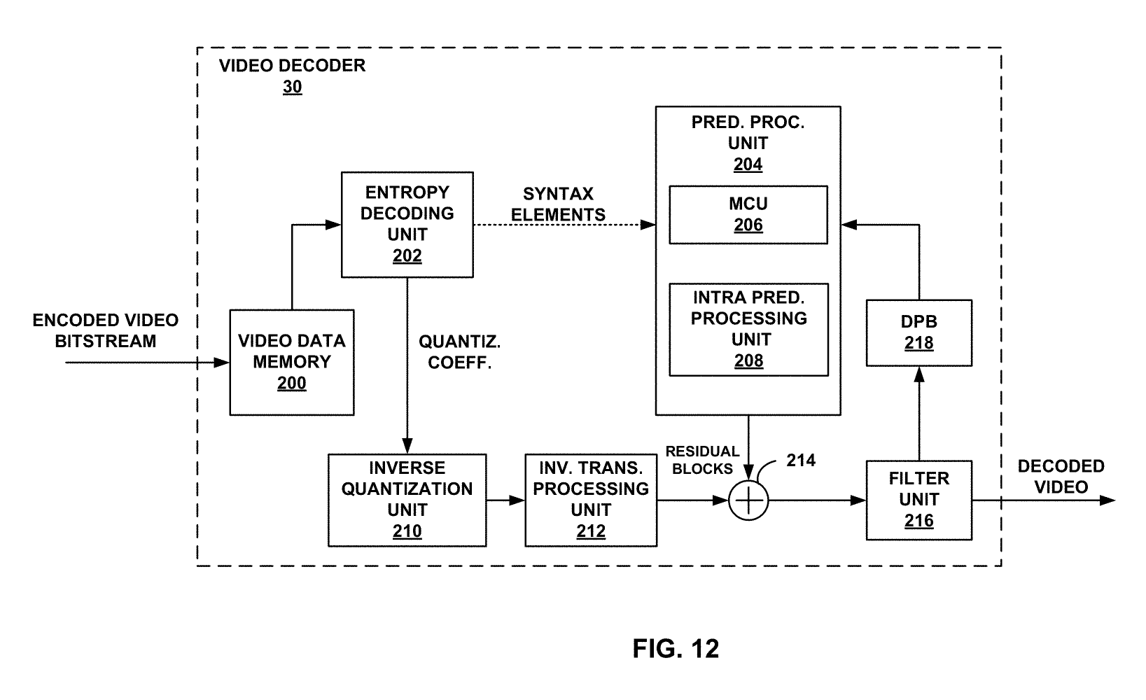

FIG. 3 shows a flow chart of an example decoder, such as the HEVC decoder described in C. Fu, E. Alshina, A. Alshin, Y. Huang, C. Chen, Chia. Tsai, C. Hsu, S. Lei, J. Park, W. Han, “Sample adaptive offset in the HEVC standard,” IEEE Trans. Circuits Syst. Video Technol., 22(12): 1755-1764 (2012) (Fu et al.), and further describes an example of how bilateral filtering may be performed in accordance with one or more examples described in this disclosure. The video decoder shown in FIG. 3 may correspond to video decoder 30, for example. The operation of video decoder 30 is described in more detail with respect to FIG. 12. The following provides some disclosure to understand the operation of bilateral filtering in the video decoding process.

Video decoder 30 may entropy decode a bitstream that includes encoded video data (34). The resulting decoded video data may include intra-mode information (e.g., if the current block being decoded was encoded using intra-prediction), inter-mode information (e.g., if the current block being decoded was encoded using inter-prediction), sample adaptive offset information (if needed), and residue (e.g., residual values indicating a difference between the current block and a prediction block). If the current block was intra-prediction, video decoder 30 may determine intra-prediction mode information and generate a prediction block based on the intra-prediction mode information (36). If the current block was inter-predicted, video decoder 30 may determine motion information (e.g., motion vector and reference picture) for the current block and perform motion compensation to determine a prediction block based on the motion information (38). For example, video decoder 30 may identify a reference picture in the reference picture list and determine a prediction block within the reference picture.

Video decoder 30 may inverse quantize the residual data (40), and inverse transform the result to generate a residual block of video data (42). Video decoder 30 may add the prediction block (e.g., generated as part of intra-prediction information (36) or motion compensation information (38)) to the residual block to generate an unfiltered reconstructed block, as part of the reconstruction operation (44).

In one or more examples, video decoder 30 may perform bilateral filtering on the unfiltered reconstructed block (46). Although, bilateral filtering is described as occurring immediately after reconstruction operation (44), the techniques are not so limited. In one or more examples, bilateral filtering (46) may occur after deblock filtering (48), after sample adaptive offset (SAO) filtering (50), or after retrieval of the block from the reference picture buffer as part of the output (e.g., post-processing stage). Simply for ease of description, bilateral filtering (46) is described as occurring immediately after reconstruction operation (44). Because bilateral filtering may be performed in various parts of the decoding or even in an output process, bilateral filtering (46) is shown with dashed lines.

To perform bilateral filtering (46), video decoder 30 may be configured to perform the example non-local bilateral filtering, and in some examples, non-local division free bilateral filtering. For example, the unfiltered reconstructed block includes a plurality of samples. For a current sample of the block being filtered, video decoder 30 may determine a first window that encompasses the current sample and one or more additional samples, and may determine a second window that encompasses a neighboring sample to the current sample and one or more additional samples. Examples of the neighboring sample include a top, bottom, left, or right sample. In some examples, the current sample is in the center of the first window, and the neighboring sample is in the center of the second window, but the techniques are not so limited. Also, in some examples, it may be possible that the samples in the first window include samples that are outside the current block that includes the current sample, and that the samples in the second window include samples that are outside the current block that includes the current sample. However, the example techniques are not so limited, and it may be possible that all samples in the first and/or second window are inside the current block that includes the current sample, or there may be a limitation that only samples within the current block can be used as samples within the first and/or second window.

Video decoder 30 may determine differences in sample values (e.g., differences in luma values and/or chroma values) between samples in the first window and samples in the second window. As one example, video decoder 30 may determine a difference in corresponding sample values (e.g., a difference between a sample value of sample on top-left of first window and a sample value of sample on top-left of second window, a difference between a sample value of a sample next to top-left sample of first window and a sample value of a sample next to a top-left sample of a second window, and so forth). Based on the difference values, video decoder 30 may determine an input parameter variable, and determine weighting parameters of the bilateral filtering based on the input parameter variable. Example ways to determine the input parameter variable, the weighting parameters based on the input parameter variable, and the operations of the bilateral filtering are described in more detail below.

Video decoder 30 may repeat these operations for each of the neighboring samples, and for a plurality of samples within the current block. For example, for a current sample in the current block, video decoder 30 may determine a first window that includes a plurality of samples including the current sample. For filtering with respect to the top neighboring sample, video decoder 30 may determine a second window that includes a plurality of samples including the top neighboring sample. Video decoder 30 may determine a first weighting parameter for bilateral filtering with the top neighboring sample based on the first and second windows, and perform bilateral filtering to determine a first filtered sample value.

For filtering with respect to the left neighboring sample, video decoder 30 may determine a third window that includes a plurality of samples including the left neighboring sample. Video decoder 30 may determine a second weighting parameter for bilateral filtering with the left neighboring sample based on the first and third windows, and perform bilateral filtering to determine a second filtered sample value. Video decoder 30 may repeat these operations for the bottom neighboring sample and the right neighboring sample to generate third and fourth filtered sample values, respectively. Video decoder 30 may then sum the first, second, third, and fourth filtered sample values, and sum the result of that with the sample value of the current sample to generate the final filtered sample value for the current sample.

Video decoder 30 may repeat these operations for a plurality of samples within the current block to generate a non-local bilateral filtered current block. In some examples, the size of the windows used for the bilateral filtering is 3×3, but other sizes are possible such as 5×3. Also, the above, left, bottom, and right neighboring samples are used merely as one example. Other neighboring samples, such as diagonal samples (e.g., top-left, top-right, bottom-left, and bottom-right) may be used in addition to or instead of the example neighboring samples. Moreover, the neighboring samples need not necessarily be immediately neighboring samples, and use of samples further from immediately neighboring samples may be possible (e.g., samples that are more than one row or column separated from the current sample).

As described above, for a sample (e.g., pixel) in a block, there may be luma and chroma components. In some examples, the example bilateral filtering techniques described in this disclosure may be applicable only to the luma components (e.g., the sample values are luma (or intensity) values). However, the techniques are not so limited. In some examples, video decoder 30 may perform similar operations for chroma components as well. Also, in some examples, video decoder 30 may determine weighting parameters using luma values, and use the weighting parameters for non-local bilateral filtering both luma and chroma values, or vice-versa.

As illustrated in FIG. 3, after the bilateral filtering (46), video decoder 30 may have generated a bilateral filtered current block. Video decoder 30 may optionally perform deblock filtering (48) and SAO filtering (50). In examples where SAO filtering is performed, part of the result of entropy decoding (34) may be the SAO information needed for SAO filtering. After performing filtering (e.g., one or more of bilateral filtering, deblock filtering, and/or SAO filtering), video decoder 30 may store the resulting filtered block in the reference picture buffer (52). Examples of deblock filtering (48) and SAO filtering (50) are described in more detail below. Video decoder 30 may then use video data stored in the reference picture buffer as a prediction block as part of motion compensation information (38).

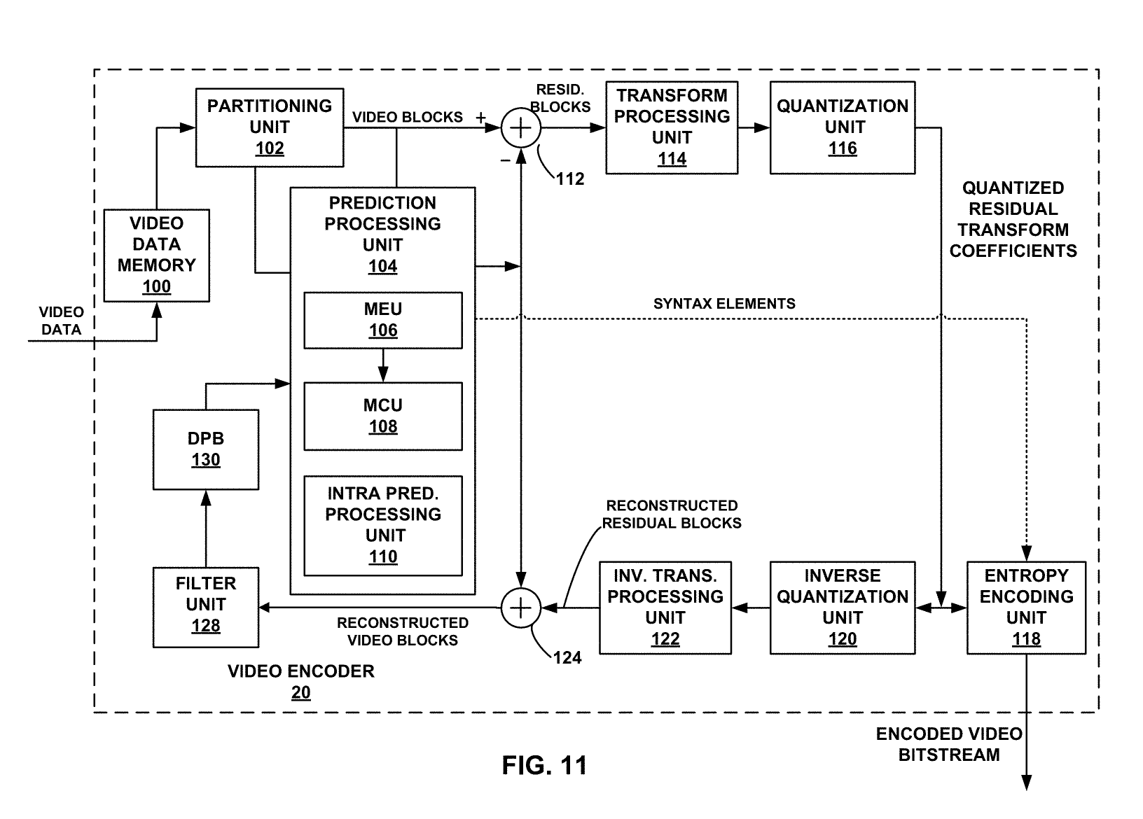

Although the above example of non-local bilateral filtering is described with respect to video decoder 30, the example techniques are not so limited. As described in more detail with respect to FIG. 11, video encoder 20 also includes a decoding loop in which video encoder 20 performs operations similar to those of the reconstruction operation performed by video decoder 30 (e.g., reconstruction operation (44)). Like video decoder 30, video encoder 20 may then perform bilateral filtering similar to the bilateral filtering techniques described above with respect to bilateral filtering (46).

As shown in FIG. 3, video decoder 30 may employ two in-loop filters including de-blocking filter (DBF) (48) and Sample adaptive offset (SAO) filter (50). HEVC utilizes deblock filtering to reduce blockiness around block boundaries. The input to this coding tool is the reconstructed image after intra or inter prediction. The deblocking filter performs detection of the artifacts at the coded block boundaries and attenuates them by applying a selected filter. Compared to the H.264/AVC deblocking filter, the HEVC deblocking filter has lower computational complexity and better parallel processing capabilities while still achieving significant reduction of the visual artifacts. Aspects of deblocking filtering in HEVC are described in A. Norkin, G. Bjontegaard, A. Fuldseth, M. Narroschke, M. Ikeda, K. Andersson, Minhua Zhou, G. Van der Auwera, “HEVC Deblocking Filter,” IEEE Trans. Circuits Syst. Video Technol., 22(12): 1746-1754 (2012).

HEVC also utilizes SAO filtering, which is a type of filtering where offsets are added to sample values (e.g., post deblocked sample values) to potentially improve the quality of decoded video. The input to SAO, in HEVC, is the reconstructed image after invoking deblocking filtering. The general concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC, the region (the unit for SAO parameters signaling) is defined to be a coding tree unit (CTU).

Two SAO types that can satisfy the requirements of low complexity are adopted in HEVC: edge offset (EO) and band offset (BO). An index of SAO type is coded (which is in the range of [0, 2]). For EO, the sample classification is based on comparison between current samples and neighboring samples according to 1-D directional patterns: horizontal, vertical, 135° diagonal, and 45° diagonal.

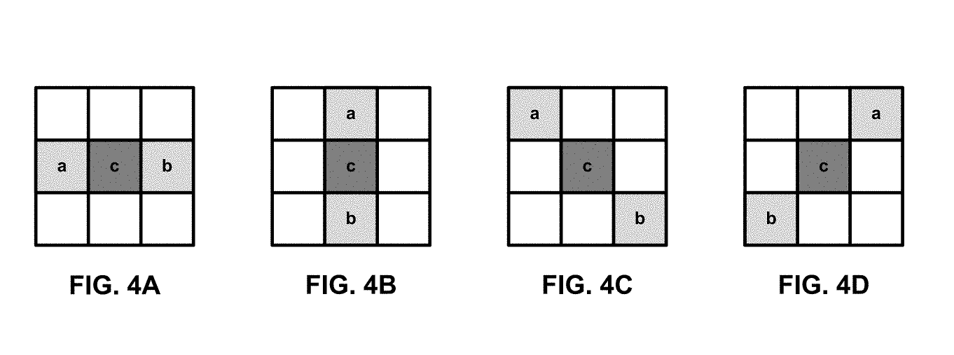

FIGS. 4A-4D show an example of four 1-D directional patterns for EO sample classification: horizontal (EO class=0), vertical (EO class=1), 135° diagonal (EO class=2), and 45° diagonal (EO class=3). “Sample adaptive offset in the HEVC standard,” Fu et al., cited above, includes a description for EO sample classification.

According to the selected EO pattern, five categories denoted by edgeIdx in Table I are further defined. For edgeIdx equal to 0˜3, the magnitude of an offset may be signaled while the sign flag is implicitly coded, i.e., negative offset for edgeIdx equal to 0 or 1 and positive offset for edgeIdx equal to 2 or 3. For edgeIdx equal to 4, the offset is always set to 0 which means no operation is required for this case.

TABLE I
classification for EO

| Category | |
|---|---|
| (edgeIdx) | Condition |
| 0 | c < a && c < b |
| 1 | (c < a && c==b) \|\| (c==a && c<b) |
| 2 | (c > a && c==b) \|\| (c == a && c > b) |
| 3 | c > a && c > b |
| 4 | None of the above |

For BO, the sample classification is based on sample values. Each color component may have its own SAO parameters. BO implies one offset is added to all samples of the same band. The sample value range is equally divided into 32 bands. For 8-bit samples ranging from 0 to 255, the width of a band is 8, and sample values from 8k to 8k+7 belong to band k, where k ranges from 0 to 31. The average difference between the original samples and reconstructed samples in a band (i.e., offset of a band) is signaled to the decoder. There is no constraint on offset signs. Only offsets of four consecutive bands and the starting band position are signaled to the decoder (e.g., video decoder 30).

To reduce the signaling overhead associated with signaling side information (e.g., offset types and offset values), multiple CTUs may be merged together (either by copying the parameters from an above CTU (through setting sao_merge_left_flag equal to 1) or a left CTU (through setting sao_merge_up_flag equal to 1)) to share SAO parameters.

In addition to the modified deblocking (DB) and HEVC SAO methods, JEM has included another filtering method, called Geometry transformation-based Adaptive Loop Filtering (GALF). GALF aims to improve the coding efficiency of Adaptive Loop Filtering (ALF) studied in the HEVC stage by introducing several new aspects. ALF is aiming to minimize the mean square error between original samples and decoded samples by using a Wiener-based adaptive filter. Samples in a picture are classified into multiple categories and the samples in each category are then filtered with their associated adaptive filter. The filter coefficients may be signaled or inherited to optimize the trade-off between the mean square error and the overhead. A Geometry transformation-based ALF (GALF) scheme may be considered to further improve the performance of ALF. GALF introduces geometric transformations, such as rotation, diagonal and vertical flip, to be applied to the samples in a filter support region depending on the orientation of the gradient of the reconstructed samples before ALF. The input to ALF/GALF is the reconstructed image after invoking SAO.

In M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-B0060, 2^{nd} Meeting: San Diego, USA, 20 February-26 Feb. 2016, and M. Karczewicz, L. Zhang, W.-J. Chien, X. Li, “EE2.5: Improvements on adaptive loop filter,” Exploration Team (JVET) of ITU-T SG 16 WP 3 and ISO/IEC JTC 1/SC 29/WG 11, Doc. JVET-00038, 3^{rd} Meeting: Geneva, CH, 26 May-1 June 2016, the Geometric transformations-based ALF (GALF) is proposed and has been adopted to the most recent version of JEM, i.e., JEM3.0. In GALF, the classification is modified with the diagonal gradients taken into consideration and geometric transformations could be applied to filter coefficients. Each 2×2 block is categorized into one out of 25 classes based on its directionality and quantized value of activity. The details are described in the following examples.

Another filtering technique is bilateral filtering. Bilateral filtering was formerly proposed by C. Tomasi and R. Manduchi, “Bilateral filtering for gray and color images,” in Proc. of IEEE ICCV, Bombay, India, January 1998. Bilateral filtering was proposed to avoid undesirable over-smoothing for pixels in the edge. One idea of bilateral filtering is that in the weighting the pixel values of the neighboring sample values themselves are taken into account to weight more of those pixels with similar luminance or chrominance values. A sample located at (i, j), may be filtered using its neighboring sample (k, l). The weight ω(i, j, k, l) is the weight assigned for sample (k, l) to filter the sample (i, j), and it is defined as:

$$ω ( i , j , k , l ) = {e}^{( - \frac{{( i - k )}^{2} + {( j - l )}^{2}}{2 {σ}_{d}^{2}} - \frac{{‖ I ( i , j ) - I ( k , l ) ‖}^{2}}{2 {σ}_{r}^{2}} )} \qquad ( 1 )$$

I(i, j) and I(k, l) are the intensity value of samples (i, j) and (k,l) respectively. σ_{d} is the spatial parameter and σᵣ is the range parameter. The filtering process with the filtered sample value denoted by I_{D}(i,j) could be defined as:

$${I}_{D} ( i , j ) = \frac{{\sum }_{k , l} I ( k , l ) * ω ( i , j , k , l )}{{\sum }_{k , l} ω ( i , j , k , l )} \qquad ( 2 )$$

The properties (or strength) of the bilateral filter are controlled by the following two parameters. Samples located closer to the sample to be filtered, and samples having smaller intensity difference relative to the sample to be filtered, may have larger weights than samples further away and with larger intensity difference.

In Jacob Strom, Per Wennersten, Ying Wang, Kenneth Andersson, Jonatan Samuelsson, “Bilateral filter after inverse transform,” JVET-D0069, 4th Meeting: Chengdu, CN, 15-21 Oct. 2016, each reconstructed sample in the transform unit (TU) is filtered using its direct neighboring reconstructed samples only.

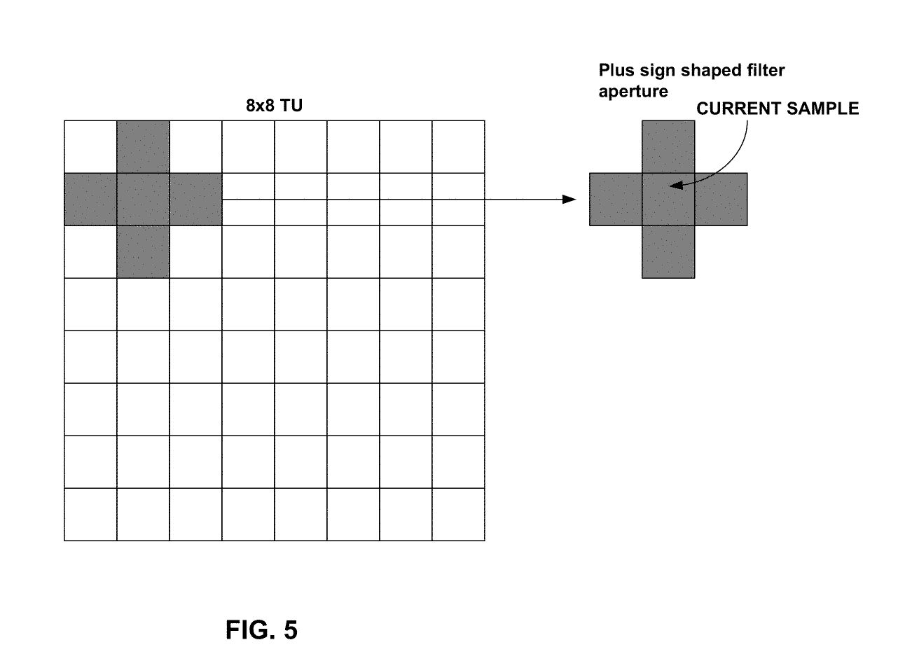

FIG. 5 shows an example of one sample and its neighboring four samples utilized in bilateral filtering process. The filter has a “plus” (+) sign shaped filter aperture centered at the sample to be filtered, as depicted in FIG. 5, where σ_{d} is to be set based on the transform unit size (eq. 3), and σᵣ is to be set based on the quantization parameter (QP) used for the current block (eq. 4).

$$\begin{matrix}{σ}_{d} = 0.92 - \frac{min ( 16 , min ( TU block width , TU block height ) )}{40} & ( 3 ) \\ {σ}_{r} = max ( \frac{( QP - 17 )}{2} , 0.01 ) & ( 4 )\end{matrix}$$

In J. Strom, P. Wennersten, K. Andersson, J. Enhorn, “Bilateral filter strength based on prediction mode,” JVET-E0032, 5th Meeting: Geneva, CH, 12-20 Jan. 2017, hereby incorporated by reference in its entirety, to further reduce the coding loss under low delay configuration, the filter strength is further designed to be dependent on the coded mode. For intra-coded blocks, the above equation (e.g., eq. 3) is still used. For inter-coded blocks, the following equation is applied:

$${σ}_{d} = 0.72 - \frac{min ( 8 , min ( TU block width , TU block height ) )}{40} \qquad ( 5 )$$

The different values for σ_{d} means that filter strength for inter prediction blocks is relatively weaker compared to that of intra prediction blocks. Inter predicted blocks typically have less residual than intra predicted blocks and therefore the bilateral filter is designed to filter the reconstruction of inter predicted blocks less.

The output filtered sample value I_{D}(i, j) is calculated as:

$${I}_{F} ( i , j ) = \frac{{\sum }_{k , l} I ( k , l ) * ω ( i , j , k , l )}{{\sum }_{k , l} ω ( i , j , k , l )} \qquad ( 6 )$$

Due to the fact that the filter only touches the sample and its 4-neighbors, this equation can be written as

$${I}_{F} = \frac{{I}_{C} {ω}_{C} + {I}_{L} {ω}_{L} + {I}_{R} {ω}_{R} + {I}_{A} {ω}_{A} + {I}_{B} {ω}_{B}}{{ω}_{C} + {ω}_{L} + {ω}_{R} + {ω}_{A} + {ω}_{B}} \qquad ( 7 )$$

where I_{c} is the intensity of the center sample, and I_{L}, I_{R}, I_{A} and I_{B} are the intensities for the left, right, above and below samples, respectively. In the above example, intensity values (e.g., luma values) are used, but chroma values may be used instead of or in addition to intensity values. Likewise, ω_{C} is the weight for the center sample, and ω_{L}, ω_{R}, ω_{A} and ω_{B} are the corresponding weights for the neighboring samples. The filter only uses samples within the block for filtering; weights outside the block are set to 0.

In order to reduce the number of calculations, the bilateral filter in the JEM has been implemented using a look-up-table (LUT). For every QP, there is a one-dimensional lookup table (LUT) for the values ω_{L}, ω_{R}, ω_{A} and ω_{B} where the value

$${ω}_{other} = round ( 65 * {e}^{( - \frac{1}{2 * {0.82}^{2}} - \frac{{‖ I - {I}_{C} ‖}^{2}}{2 {σ}_{r}^{2}} )} ) \qquad ( 8 )$$

is stored, where σᵣ² is calculated from (eq. 4) depending upon QP. Since σ_{d}=0.92−4/40=0.82 in the LUT, it can be used directly for the intra M×N with minimum(M, N) equal to 4 case with a center weight ω_{C} of 65, which represents 1.0. For the other modes (i.e., intra M×N but minimum (M, N) unequal to 4, inter K×L blocks), the same LUT may be used, but instead using a center weight of

$${ω}_{C} = round ( 65 * \frac{{e}^{- \frac{1}{2 * {0.82}^{2}}}}{{e}^{- \frac{1}{2 * {σ}_{d}^{2}}}} ) , \qquad ( 9 )$$

where α_{d} is obtained by (eq. 3) or (eq. 5). The final filtered value is calculated as

$${I}_{F} = floor ( \frac{\begin{matrix}{I}_{C} {ω}_{C} + {I}_{L} {ω}_{L} + {I}_{R} {ω}_{R} + {I}_{A} {ω}_{A} + {I}_{B} {ω}_{B} + \\ ( ( {ω}_{C} + {ω}_{L} + {ω}_{R} + {ω}_{A} + {ω}_{B} ) ≫ 1 )\end{matrix}}{{ω}_{C} + {ω}_{L} + {ω}_{R} + {ω}_{A} + {ω}_{B}} ) \qquad ( 10 )$$

where the division used is integer division and the term (ω_{c}+ω_{L}+ω_{R}+ω_{A}+ω_{B}) >>1 is added to get correct rounding.

In the JEM reference software, the division operation in equation 10 is replaced by LUT, multiplication and shift operations. To reduce the size of the numerator and denominator, equation 10 is further refined to

$${I}_{F} = {I}_{C} + \frac{{ω}_{L} ( {I}_{L} - {I}_{C} ) + {ω}_{R} ( {I}_{R} - {I}_{C} ) + {ω}_{A} ( {I}_{A} - {I}_{C} ) + {ω}_{B} ( {I}_{B} - {I}_{C} )}{{ω}_{C} + {ω}_{L} + {ω}_{R} + {ω}_{A} + {ω}_{B}} \qquad ( 11 )$$

In the JEM reference software, equation 11 is implemented in a way that the division could be implemented by two look-up tables, and equation 11 could be rewritten as:

$${I}_{F} = {I}_{C} + sign ( PixelDeltaSum ) * ( ( sign ( PixelDeltaSum ) * PixelDeltaSum + o ) * LUT ( sumWeights ) >> (14+ DivShift ( sumWeights ) ) ) \\ PixelDeltaSum = ( {ω}_{L} ( {I}_{L} - {I}_{C} ) + {ω}_{R} ( {I}_{R} - {I}_{C} ) + {ω}_{A} ( {I}_{A} - {I}_{C} ) + {ω}_{B} ( {I}_{B} - {I}_{C} ) \\ sumWeights = {ω}_{C} + {ω}_{L} + {ω}_{R} + {ω}_{A} + {ω}_{B} \\ o = PixelDeltaSum + sign ( PixelDeltaSum ) \\ sign ( x ) = x \text{>=} 0 ? 1 \text{:} - 1 ; \qquad ( 12 )$$

The two look-up tables are the look-up table LUT to get an approximated value for each 1/x (x is an positive integer value) after shifting, and a look-up table DivShift to define the additional shift value for input x. J. Strom, P. Wennersten, K. Andersson, J. Enhorn, “EE2-JVET related: Division-free bilateral filter,” JVET-F0096, 6th Meeting: Hobart, CH, 31 March-7 Apr. 2017, provides more details.

The filter is turned off if QP<18 or if the block is of inter type and the block dimensions are 16×16 or larger.

It is noted that the such a bilateral filtering method may only be applied to luma blocks with at least one non-zero coefficient. For chroma blocks and luma blocks with all zero coefficients, the bilateral filtering method may always disabled.

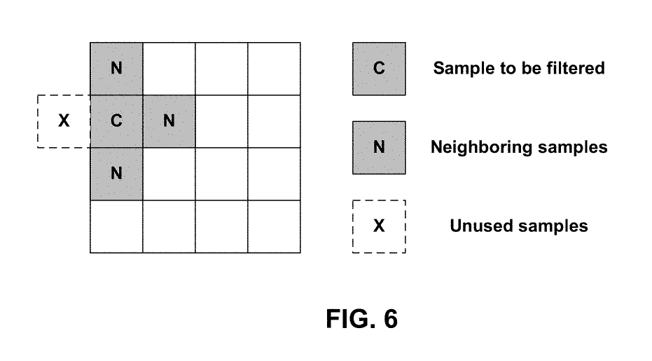

FIG. 6 shows an example of one sample and its neighboring four samples utilized in bilateral filtering process. For samples located at a TU top and left boundaries (i.e., top row and left column), only neighboring samples within the current TU may be used to filter a current sample, as shown in the example of FIG. 6.

In U.S. Provisional Application No. 62/528,912, filed Jul. 5, 2017, and entitled DIVISION-FREE BILATERAL FILTER (hereinafter '912 application), a division-free bilateral filtering (DFBil) method is proposed in which, for one sample to be filtered, the filtering process could be defined as:

$${I}_{F} = {I}_{C} + {\sum }_{i = 1}^{N} W ( abs ( X ) ) * ( {I}_{i} - {I}_{c} )$$

where X is Iᵢ−I_{C}, I_{C} is the intensity of the current sample, Iᵢ is the intensity of the neighboring samples, and I_{F} is the modified intensity of the current sample after performing DFBiL, and Iᵢ and W(abs(X)) are the intensity and weighting parameter for the i-th neighboring sample, respectively.

$${w}_{i} = {Dis}_{i} * {Rang}_{i}$$

$${Rang}_{i} = {e}^{( - \frac{\vert \vert X {\vert \vert}^{2}}{2 {σ}_{r}^{2}} )} , \\ X = {I}_{i} - {I}_{c}$$

$${Dis}_{i} = \frac{{TempD}_{i}}{1 + {Σ}_{j = 1}^{N} {TempD}_{j}}$$

$${TempD}_{i} = {e}^{( - \frac{{10}^{4} * sqrt ( {( i - k )}^{2} + {( j - l )}^{2} )}{2 {σ}_{d}^{2}} )}$$

$${σ}_{r} = {( QP - minDFBilQP + {2}^{*} {Index}_{r} - {2}^{*} ( RCandNum \text{/} 2 ) )}^{*} 2$$

$${σ}_{d} = DCandidateList [ {Index}_{d} ]$$

minDFBilQP indicates the minimum QP that could apply DFBil, e.g., it is set to 17. Index_{d} and Indexᵣ may be signaled per quad-tree partition.

In the above example, for bilateral filtering, video encoder 20 and video decoder 30 determine a weighting parameter based on the value of the variable X. For example, the variable X is an input value to determine the value of Rang, as shown above. In the above example, the value of X is Iᵢ−I_{c}, which means that X is equal to the sample value (e.g., intensity or luma value in this example) of a neighboring sample to the current sample minus the sample value (e.g., intensity or luma value in this example) of the current sample. Video encoder 20 and video decoder 30 may determine the value of Dis as described above.

The value of Dis is based on the spatial distance between the current sample and the neighboring sample. For example, as shown above, Dis is based on the value of TempD, and TempD is based on the value of i, k, j, and l. The variable (i,j) are the coordinates of the current sample, and the variable (k, l) are the coordinates of the neighboring sample. The values of Range and Dis are also based on the variables σᵣ and σ_{d}, respectively. The equations to determine the variables σᵣ and σ_{d} are provided above, and the variables needed for the equations may be signaled or derived. Accordingly, video encoder 20 and video decoder 30 may determine differences between sample values of the current sample and the neighboring sample to determine the value of Rang, and determine a spatial distance between the neighboring sample and the current sample to determine the value of Dis.

The weighting parameter is then equal to Dis*Rang, and the final filtered value of the current sample can be calculated as follows:

$${I}_{F} = {I}_{C} + {\sum }_{i = 1}^{N} W ( abs ( X ) ) * ( {I}_{i} - {I}_{c} )$$

The above equations to determine the value of weighting parameter and the equation to determine the final filtered value is provided as one example, and should not be considered limiting. There may be other ways in which to determine the weighting parameter based on the value of the variable X, and other example ways to apply the filter. As described in more detail, this disclosure describes example ways in which to determine the value of the variable X that can be used to determine weighting parameters and from there the final filtered value for the current sample.

In one or more examples, the value of the weighting parameter is a function of the Rang value, and the Rang value is a function of the variable X. Therefore, the weighting parameter is a function of the variable X. In the above example, the value of X is Iᵢ−I_{c}. Therefore, the weighting parameter is determined based on difference of sample values between only a neighboring sample and a current sample. In one or more examples described in this disclosure, the techniques to determine the value of the variable X may utilize a plurality of samples, such as intensity (e.g., luma values) of the sample values of the samples. From the value of X, video encoder 20 and video decoder 30 may determine the Rang value. In addition to the Rang value, video encoder 20 and video decoder 30 may determine the value of Dis, which is based on spatial distances between the samples (e.g., the above equation for TempD).

As one example, video encoder 20 and video decoder 30 may determine a first window that includes the current sample and a plurality of samples, and a second window that includes the neighboring sample, with which the current sample is to be filtered, and a plurality of samples. Video encoder 20 and video decoder 30 may determine differences in sample values between the first and second windows, and determine the value of the variable X based the differences. In this manner, rather than relying on just the sample value of the current sample being filtered, and the sample value of the neighboring sample, with which the current sample is being filtered, the example techniques utilize a plurality of samples that include the current sample being filtered and a plurality samples that include the neighboring sample, with which the current sample is being filtered, to determine the value of X. Such example techniques may result in more optimal weighting parameter determinations.

In addition, video encoder 20 and video decoder 30 may determine difference in a spatial distance between the current sample and the neighboring sample (e.g., determine TempD, and determine Dis based on TempD, as described above). Based on the determined difference in the sample values (e.g., the value of X), video encoder 20 and video decoder 30 may determine the value of Rang. Based on the determined spatial distance, video encoder 20 and video decoder 30 may determine the value of Dis. Based on Rang and Dis, video encoder 20 and video decoder 30 may determine the value of the weighting parameter. In such examples, the weighting parameter associated with the neighboring sample is based on the determined difference in the sample values and the determined spatial distance.

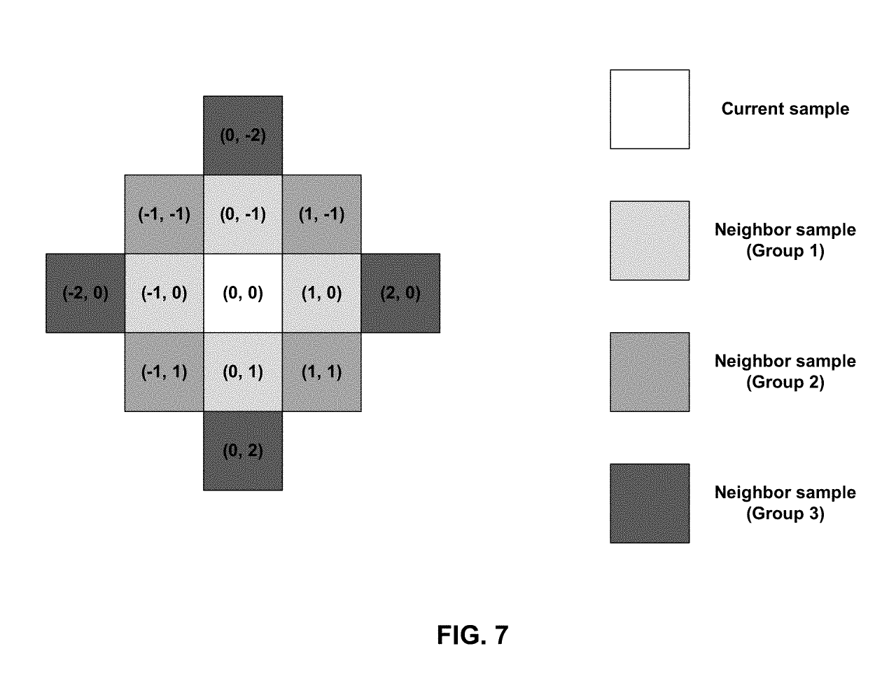

According to one technique to apply DFBil, the neighboring samples used in the DFBil method are those located in a template. In one example, the template may include several neighboring samples which are spatially close to the current sample. An example of current sample and neighboring samples used in DFBil is depicted in FIG. 7. For example, in FIG. 7, the current sample to be filtered is represented as (0, 0), and the neighboring samples are shown relative to the current sample. For instance, sample (−1, 0) is located to the left of the current sample, and sample (1, 0) is located to the right of the current sample. Sample (−2, 0) is located two to the left of the current sample, and sample (2, 0) is located two to the right of the current sample.

The design of bilateral filtering proposed in JVET-D0069, JVET-E0032, and JVET-F0096 may have several problems. Methods described in the '912 application may potentially, but not necessarily, have some issues.

For instance, some example bilateral filter methods directly use the intensity (sample value) differences between a current sample and one of the neighboring samples to decide the weighting factor (filter parameter) associated with the neighboring sample. While in some cases, there could be outliers which may result in sub-optimal weighting parameters, as described above.

As another example, for samples located at the top row/left column, the neighboring samples outside the current block are not utilized in the bilateral filtering process. This may result in two problems: 1) additional check of the availability of neighboring samples; and 2) lower coding gains since only current block information is considered.

The following describes example techniques which may address the issues mentioned above. As an example, a non-local division-free bilateral filtering (NLDF-Bil) method is proposed. In NLDF-Bil, to select a weighting parameter associated with a current sample to be filtered and one of its neighboring sample, the sample values (e.g., intensity (luma) or chroma values) difference between the current sample and one of its neighboring sample is replaced by a representative intensity difference among two windows covering the current sample and the neighboring sample.

The following example techniques may apply individually. Alternatively, any combination of them may apply. Also, the example techniques may not only be applied to either bilateral filter in JVET-D0069, JVET-E0032, and JVET-F0096, or the division-free bilateral filter in the '912 application, but may also be applied to other filters that utilize samples to calculate the filter parameters.

Video encoder 20 or video decoder 30 may define the window covering a sample in one block as a K×L window (K, L are both positive values and K×L is greater than 1) covering the sample. In one example, the window covers several spatially neighboring samples of the current sample. Alternatively, the window may cover one or more samples in different pictures (e.g., in one or multiple reference pictures). In another example, the window covers several samples in different pictures, and the samples are indicated by given motion vector(s). The motion vector(s) may be the ones associated with the current sample used for motion compensation. Alternatively or additionally, the motion vector may be a default value (e.g., (0, 0)). Alternatively or additionally, the motion vectors may be derived by motion vectors from a spatial neighboring block or predicted from the co-located block in a different picture. Alternatively or additionally, the motion vectors are derived by template matching. In one example, the motion vector(s) may be rounded to the nearest integer.

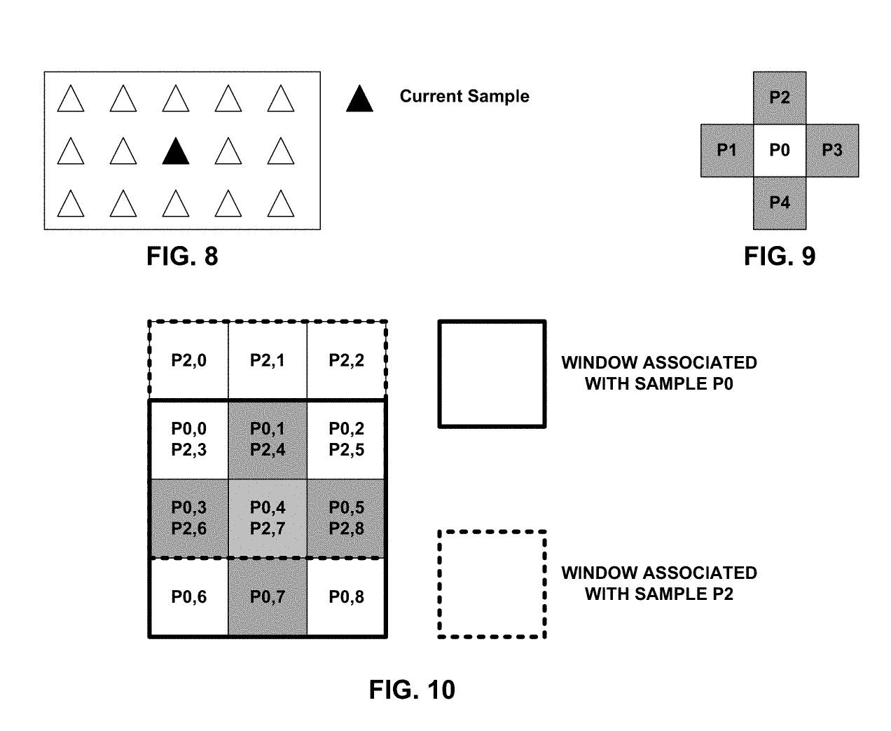

Video encoder 20 or video decoder may define the window such that the pixel should be located at the center of the window. FIG. 8 is an example of samples of a window covering the current sample, where K=5, L=3. As illustrated, the current sample is located in the center of the window. In one example, K and L are both set to 3.

For example, in FIG. 8, the current sample is illustrated with full shading, and the other samples that form the first window are shown without shading. In this example, the first window includes the current sample and one or more neighboring samples. As described in more detail below, because the current sample is filtered with respect to a neighboring sample, the first window may include the current sample and the neighboring sample. Similarly, the second window that includes the neighboring sample may also include the current sample that is being filtered. In some examples, the current sample and the neighboring sample may be centered in respective first and second windows, but the example techniques are not so limited.

Also, the example of FIG. 8 is merely one example. As described above, the first window need not necessarily include samples only for the current picture that includes the current sample. In some examples, the first window includes samples from different pictures (e.g., pictures other than the current picture that includes the current sample). For example, the samples in the first window may include a sample in a reference picture that is spatially neighboring where the current sample would be located in the reference picture. For instance, video encoder 20 and video decoder 30 may determine where the current sample would be located in the reference picture, and then determine samples that neighbor that location in the reference picture. Video encoder 20 and video decoder 30 may determine these samples in the reference picture as being part of the first window. In some examples, video encoder 20 and video decoder 30 may utilize multiple reference pictures to determine the first window (e.g., identify some samples of the first window from a first reference, some samples of the first window from a second window, and so forth).

In some examples, rather than determining where the current sample would be located in a reference picture, video encoder 20 and video decoder 30 may determine a motion vector (e.g., the motion vector used for motion compensation, a motion vector of a neighboring block, a zero motion vector, a default motion vector, by template matching based on motion vector of matched template, by rounding of a motion vector, etc.), and determine a location in a reference picture based on the motion vector. Video encoder 20 and video decoder 30 may determine neighboring samples based on the location identified by the motion vector. In some examples, a zero motion vector is the same as determining a location of where the current sample would be in the reference picture.

As depicted in FIG. 9, the filtering process for filtering a sample denoted by P0 may involve its four neighbors, denoted by P1, P2, P3, P4. FIG. 9 is an example of a template for a current sample (P0) and its four neighbors used in non-local bilateral filter. In one or more examples, video encoder 20 and video decoder 30 may be configured to perform the example techniques described in this disclosure with respect to the samples shown in FIG. 9.

For example, as described in more detail, video encoder 20 and video decoder 30 may determine a first window that includes sample P0, and determine a second window that includes sample P1. Video encoder 20 and video decoder 30 may perform the example techniques described in this disclosure to determine a value for the variable X, and determine a weighting parameter for filtering with respect to sample P1 based on the value of the variable X. Video encoder 20 and video decoder 30 may determine another window that includes sample P2, and repeat these example operations determine a weighting parameter for filtering with respect to sample P2. Video encoder 20 and video decoder 30 may determine another window that includes sample P3, and repeat these example operations to determine a weighting parameter for filtering with respect to sample P3. Video encoder 20 and video decoder 30 may determine another window that includes sample P4, and repeat these example operations to determine a weighting parameter for filtering with respect to sample P4. The weighting parameters may be fractional values, less than one, or may be greater than one.

In the above example, the first window that includes sample P0 may be the same for each of P1-P4, but the example techniques are not limited. In some examples, video encoder 20 and video decoder 30 may determine a different window that includes the sample P0 when filtering with respect to one of P1, P2, P3, or P4.

Moreover, P1, P2, P3, and P4 samples are shown as one example, and other neighboring samples may be possible with which sample P0 is filtered. Also, in some examples, video encoder 20 and video decoder 30 may perform filtering only on luma values. In some examples, video encoder 20 and video decoder 30 may perform filtering only on chroma values. In some examples, video encoder 20 and video decoder 30 may perform filtering on both luma and chroma values. It may be possible for video encoder 20 and video decoder 30 to determine weighting parameters once (e.g., for luma or chroma values) and use the determined weighting parameters when filtering the other one of the luma or chroma values. In some examples, video encoder 20 and video decoder 30 may separately determine weighting parameters for luma and chroma values.

When selecting the weighting parameter for Pi (i=1 . . . 4), instead of directly using abs(Pi−P0) as the input (e.g., rather than determining the variable X=Pi−P0, where and example of Pi is Iᵢ and an example of P0 is I_{C}, from above), video encoder 20 or video decoder 30 may utilize two windows covering P0 and Pi. When i is equal to 2, the windows for covering P0 and P2 are depicted in FIG. 10. In one example, K and/or L may depend on the block size. For example, larger block sizes may choose larger window sizes. In one example, K and/or L may depend on the coordinate of the sample relative to a current block, or current slice/tile, or current picture. In one example, K and/or L may depend on whether the sample is located at the picture/slice/tile boundary.

For example, FIG. 10 illustrates a first window in bold line, and a second window in dashed line. The first window and the second window are each 3×3 windows (e.g., K=3, and L=3), but other values of K and L are possible. In FIG. 10, six sample values are identified by two coordinates. This is because these six sample values belong to both the first window and the second window.

For instance, the first window includes samples P0,0, P0,1, P0,2, P0,3, P0,4, P0,5, P0,6, P0,7, and P0,8. This is the way to identify the nine samples that make up the first window. For example, in the identifier P0,N, the P0 means that the sample is within the window associated with sample P0, which is the sample to be filtered (e.g., a first window that includes the current sample). The value of N identifies the location of the sample within the window. In this example, the current sample that is to be filtered is P0,4, and accordingly, current sample P0,4 is located in the center of the first window. The current sample need not necessarily be located in the center of the first window, but is illustrated as such in this example.

The second window includes samples P2,0, P2,1, P2,2, P2,3, P2,4, P2,5, P2,6, P2,7, and P2,8. This is the way to identify the nine samples that make up the second window. For example, in the identifier P2,N, the P2 means that the sample is within the window associated with sample P2, which is a sample with which sample P0 is to be filtered (e.g., a second window that includes a neighboring sample with which current sample is to be filtered). The value of N identifies the location of the sample within the window. In this example, the neighboring sample with which the current sample is to be filtered is P2,4, and accordingly, neighboring sample P2,4 is located within the center of the second window. The neighboring sample need not necessarily be located in the center of the second window, but is illustrated as such in this example.

As illustrated, there are six samples that are shared by both the first and second windows. For instance, the top-left sample of the first window (e.g., P0,0) is the same sample as the first sample in the second row of the second window (e.g., P2,3). Hence, this sample is identified as P0,0 P2,3 in FIG. 10. As can also be seen in FIG. 10, in this example, the first window includes the sample to be filtered (e.g., P0,4) and also includes the neighboring sample with which the current sample is to be filtered (e.g., P2,4). Similarly, the second window includes the neighboring sample (e.g., P2,4) with which the current sample is to be filtered, and also includes the current sample that is to be filtered (e.g., P0,4). However, the example techniques are not so limited, and the first and second windows need not necessarily include both the current sample and the neighboring sample.

Also, as illustrated, the first window includes samples that are the same as samples in the second window (e.g., P0,0, P0,1, P0,2, P0,3, P0,4, and P0,5), and some samples that are not the same (e.g., P0,6, P0,7, and P0,8). The second window includes samples that are same as samples in the first window (e.g., P2,3, P2,4, P2,5, P2,6, P2,7, and P2,8), and some samples that are not the same (e.g., P2,0, P2,1, and P2,3). However, the example techniques are not so limited. The first and second windows need not necessarily include some of the same samples, or may include more or fewer samples than those illustrated in FIG. 10.

FIG. 10 illustrates an example of the second window used when filtering with respect to sample P2. Video encoder 20 and video decoder 30 may determine similar windows when filtering with respect to samples P1, P3, and P4. The window sizes when filtering may be different or the same.

Based on the first and second windows (e.g., where the second window is for P1, P2, P3, or P4), video encoder 20 and video decoder 30 may determine a value for the variable X, from which video encoder 20 and video decoder 30 may determine a value of Rang, and from which video encoder 20 and video decoder 30 may determine a weighting parameter. Video encoder 20 and video decoder 30 may repeat these operations for each of P1, P2, P3, and P4 to determine respective weighting parameters (e.g., determine weighting parameters for P1, P2, P3, and P4). Video encoder 20 and video decoder 30 multiply each of the respective weighting parameters with (Pi−P0), where Pi is the sample value of the respective neighboring sample (e.g., P1, P2, P3, or P4) and P0 is the sample value of the current sample. Video encoder 20 and video decoder 30 may sum the values together and sum the resulting value with P0 to determine the final filtered sample value.

In some examples, when filtering the current sample, the samples in the first window or the second window may be those of previously filtered values. As one example, referring to FIG. 10, the sample located at P0,3 may have been previously filtered when the sample located at P0,3 was the current sample. Therefore, there may be two options for the sample value for the sample located at P0,3: the filtered sample value or the original, unfiltered sample value. The same may be true for samples in the second window. In some examples, video encoder 20 and video decoder 30 may utilize the unfiltered, original values for the samples in the first and second windows. In some examples, video encoder 20 and video decoder 30 may utilize the filtered values for the samples in the first and second windows.

The following describes some example techniques that may be independent or combined with the above techniques for criteria for selecting the weighting parameter using samples in the window. For example, the following describes example ways in which to determine the value of the variable X. In one or more examples, the value of the variable X is determined based on differences between corresponding samples in the first and second window. As one example, video encoder 20 and video decoder 30 may determine the difference between samples located in the top-left corner of both the first and second windows, determine the difference between samples located next to the top-left corner of both the first and second windows, and so forth. For instance, referring back to FIG. 10, video encoder 20 and video decoder 30 may determine the difference between P2,0 and P0,0, P2,1 and P0,1, P2,2 and P0,2, P2,3 and P0,3, P2,4 and P04, P2,5 and P0,5, P2,6 and P06, P2,7 and P0,7, and P2,8 and P0,8. Based on these difference values, video encoder 20 and video decoder 30 may determine a value for the variable X, and determine the weighting parameter.

For instance, suppose samples within the window associated with Pi are denoted by Pi,j (j=0 . . . (K*L−1)) per given scan order. P0 is the sample to be filtered. Also, in the following, Pi-P0 is one example of the value of the variable X, and the equation for determining the variable X is replaced by one or more of the example equations provided below.

In one example, the difference (e.g., difference in luma or chroma values) between Pi and P0 may be replaced by the average absolute intensity differences of samples in the two windows. That is, abs(Pi−P0) may be replaced by

$$\frac{{Σ}_{j = 0}^{K * L - 1} abs ( Pi , j - P 0 , j )}{K * L} .$$

Alternatively or additionally, the average of weighted absolute differences of samples in the two windows may be used. For example, abs(Pi−P0) may be replaced by

$$\frac{{Σ}_{j = 0}^{K * L - 1} weight ( j ) * abs ( Pi , j - P 0 , j )}{K * L * {Σ}_{j = 0}^{K * L - 1} weight ( j )} .$$

Alternatively or additionally, the difference between Pi and P0 may be replaced by the root of average of square differences of samples in the two windows. That is, abs(Pi−P0) may be replaced by

$$\sqrt{\frac{{Σ}_{j = 0}^{K * L - 1} ( Pi , j - P 0 , j ) * ( Pi , j - P 0 , j )}{K * L}} .$$

Alternatively or additionally, the difference between Pi and P0 may be replaced by the power of 1/α of average of absolute differences of samples powered by a in the two windows. That is, abs(Pi−P0) may be replaced by

$${( \frac{{Σ}_{j = 0}^{K * L - 1} {abs ( Pi , j - P 0 , j )}^{α}}{K * L} )}^{\frac{1}{α}} .$$

Alternatively or additionally, the difference between Pi and P0 may be replaced by the root of average of weighted square differences of samples in the two windows. That is, abs(Pi−P0) may be replaced by

$$\sqrt{\frac{{Σ}_{j = 0}^{K * L - 1} weight ( j ) * abs ( Pi , j - P 0 , j ) * ( Pi , j - P 0 , j )}{K * L * {Σ}_{j = 0}^{K * L - 1} weight ( j )} .}$$

Alternatively or additionally, the difference between Pi and P0 may be replaced by the power of 1/α of average of weighted absolute differences of samples powered by a in the two windows. That is, abs(Pi−P0) may be replaced by

$${( \frac{{Σ}_{j = 0}^{K * L - 1} weight ( j ) \cdot {abs ( Pi , j - P 0 , j )}^{α}}{K * {LΣ}_{j = 0}^{K * L - 1} weight ( j )} )}^{\frac{1}{α}} .$$

In examples where the average of weighted absolute differences of corresponding samples in the two windows may be used, where the difference between Pi and P0 may be replaced by the root of average of weighted square differences of corresponding samples in the two windows, or where the difference between Pi and P0 may be replaced by the power of 1/α of average of weighted absolute intensity differences of corresponding samples powered by a in the two windows, the weight denoted by weight(j) may depend on the distance between sample P0, j and P0, 0. Alternatively or additionally, weight(j) may also depend on the distance between Pi and P0.

Hence, the above describes various example ways in which video encoder 20 and video decoder 30 may determine the value of the variable X that is used to determine the weighting parameter. There may be other example ways in which to determine the weighting parameter based on the value of X, and the example way in which to determine the weighting parameter is merely one example.

In another example, if part of the windows associated with sample P0 and Pi are not available, e.g., part of window falls outside the current picture/slice/tile, then video encoder 20 and video decoder 30 may adjust the window size/shape accordingly that only the available samples inside the windows associated with sample P0 and Pi are considered for calculating the replacement of abs(Pi-P0).

In some examples, video encoder 20 and video decoder 30 may utilize samples outside of current block for the filtering process. In one example, video encoder 20 and video decoder 30 may utilize samples outside of the current block only for certain coding modes, such as inter-coded blocks. In one example, for intra-coded blocks, if it (e.g., current block being encoded or decoded) shares the same intra prediction modes as its above and/or left, and/or above-left neighboring blocks, samples outside of current block may be utilized.

The usage of non-local information may be dependent on the coded mode, and/or availability of neighboring samples, and/or the relative position of the sample to be filtered, and/or transform sizes, and/or other coded information. In one example, for intra-coded blocks, the usage of non-local information is not allowed. Alternatively or additionally, for a block with its above row and/or left column unavailable, the usage of non-local information is not allowed. Alternatively or additionally, for a block with width or height not greater than 16, the usage of non-local information is not allowed. Alternatively or additionally, for an inter-coded block with its above row and left column available, the usage of non-local information is allowed. Alternatively or additionally, the usage of non-local information may be dependent on the sample's relative position. For example, if a sample is located in the boundary of a block (e.g., the right most column), the usage of non-local information is not allowed.

When the usage of non-local information is disallowed, the input for selecting a weighting factor may based on the sample difference between current sample and the corresponding neighbor sample.

In some examples, the non-local division-free bilateral filter may be applied under the following example conditions. Non-local division-free bilateral filter may be applied immediately after one block is reconstructed, that is, before coding/decoding the next block. Therefore, the filtered block may be used for predicting the following blocks. Alternatively or additionally, furthermore, it may be invoked only when there is at least one non-zero transform coefficient in the block. Non-local division-free bilateral filter may be applied right after one slice/tile/picture is reconstructed, that is, before any filtering process such as deblocking filter, SAO and ALF (at (46) as illustrated in FIG. 3). Non-local division-free bilateral filter may be applied right after one slice/tile/picture is reconstructed and filtered by deblocking filter (e.g., after (48) of FIG. 3), or filtered by SAO, or filtered by ALF, or other filters (e.g., after (50) of FIG. 3).

In some examples, similar to the '912 application, the parameters used in the non-local bilateral filter may be signaled by high-level indicators, block-level indicators, or implicitly derived by analyzing the image statistics or coded information. The parameters used the non-local bilateral filter may include: the window width, height, the σᵣ, σ_{d}. The parameters may be signaled by high-level syntaxes including but not limited to: indicators at SPS, PPS, slice header. The parameters may be signaled by block-level indicators including but not limited to: CTU-level, CU-level, PU-level, TU-level, or coding block(CB)-level where CU, PU and TU does not differentiate from each other, e.g., QTBT or MTT.

The parameters may be derived by analyzing the image statistics, including but not limited to estimated noise variance or estimated image sample correlation. The parameters may depend on coded information, including but not limited to block size, shape, intra/inter coded, intra prediction direction, number of non-zero coefficients, magnitude of coefficients, and/or enhanced multiple transform (EMT)/non-separable secondary transforms (NSST)/position dependent prediction combination (PDPC) flags or indices. As one example, in equation 3 above, the value of σ_{d} is based on the TU block width and the TU block height, which is one example of the image statistics such as block size. In equation 4 above, the value of σᵣ is based on the quantization parameter (QP), which is another example of the image statistics.

In some examples, similar to '912 application, regardless of after which process the filtering process is applied, the template (covering Iᵢ) or the window may contain samples in current frame and/or previously coded frames. In one example, the motion vector(s) associated with the current sample or its spatially neighboring samples may be utilized to locate samples in a different frame. In some examples, the motion vector may be a default value (e.g., (0, 0)). The motion vectors may be derived by motion vectors from spatial neighboring block or blocks or predicted from the co-located block in a different picture. The motion vectors may be derived by template matching. In one example, furthermore, the motion vector(s) may be rounded to the nearest integer.

The following is an example technique for implementing the non-local division-free bilateral filter. The filtering process could be represented as follows.

Filtering may be without non-local information, similar to the '912 application, wherein Pᵢ indicates the i-th sample in a template, and P₀ indicates the current sample to be filtered, e.g., as follows:

$${P}_{filt} = {P}_{0} + {\sum }_{k = 1}^{n} W ( abs ( {P}_{k} - {P}_{0} ) ) * ( {P}_{k} - {P}_{0} )$$

Filtering may be with non-local information, wherein P_{k,m} indicates the m-th sample in the window associated with the k-th sample Pₖ in the template, and P_{0,m} indicates the m-th sample in the window associated with current sample P₀, e.g., as follows:

$${P}_{filt} = {P}_{0} + {\sum }_{k = 1}^{n} W ( \frac{1}{M} * {\sum }_{m = 0}^{M - 1} abs ( {P}_{k , m} - {P}_{0 , m} ) ) * ( {P}_{k} - {P}_{0} )$$

For both cases, the following may be applied:

$$W ( diff ) = round ( {f}_{range} * {f}_{spatial} * ScaleFactor )$$

$$wherein {f}_{range} = {e}^{- \frac{diff * diff}{2 * {σ}_{r}^{2}}} = {e}^{- \frac{diff * diff}{2 * ( QP - MinQP ) * ( QP - MinQP )}}$$

$${f}_{spatial} = \frac{{e}^{- \frac{1}{2 * {σ}_{d}^{2}}}}{1.0 + 4 * {e}^{- \frac{1}{2 * {σ}_{d}^{2}}}} = \frac{{e}^{- \frac{10000}{2 * modePara * modePara}}}{1.0 + 4 * {e}^{- \frac{10000}{2 * modePara * modePara}}}$$

$$modePara = [ 82 , 72 , 52 , 62 , 52 , 32 ] ( depending on block size and mode )$$

In one example, M is set to 9, as depicted in FIG. 10. The implementation of division to calculate the average absolute intensity difference in two windows may be performed by multiplication and shifting operations:

$$\frac{1}{M} * {\sum }_{m = 0}^{M - 1} abs ( {P}_{k , m} - {P}_{0 , m} ) \to ( ( {\sum }_{m = 0}^{M - 1} abs ( {P}_{k , m} - {P}_{0 , m} ) ) * 114 ) >> 10$$

$$Or$$

$$\frac{1}{M} * {\sum }_{m = 0}^{M - 1} abs ( {P}_{k , m} - {P}_{0 , m} ) \to ( ( {\sum }_{m = 0}^{M - 1} abs ( {P}_{k , m} - {P}_{0 , m} ) ) * 113 + 512 ) >> 10$$

In this way, the division operation may be removed from the process. As described above, the division operation may be more computationally expensive than multiplication and shift operations. Accordingly, by performing the example techniques described in this disclosure, video encoder 20 and video decoder 30 may perform the example non-local bilateral filtering techniques, which may be non-local division-free bilateral filtering, in some examples.

FIG. 11 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 11, video encoder 20 includes various circuitry such as programmable circuitry and/or fixed-function circuitry. The example operations of video encoder 20 may be performed by the programmable circuitry, fixed-function circuity, or a combination. The units illustrated in FIG. 11 may be individual circuits or a combination of the units may form a circuit.

Video encoder 20 includes a video data memory 100, partitioning unit 102, prediction processing unit 104, summer 112, transform processing unit 114, quantization unit 116, entropy encoding unit 118. Prediction processing unit 104 includes motion estimation unit (MEU) 106, motion compensation unit (MCU) 108, and intra prediction unit 110. For video block reconstruction, video encoder 20 also includes inverse quantization unit 120, inverse transform processing unit 122, summer 124, filter unit 128, and decoded picture buffer (DPB) 130. Filter unit 128 may be configured to perform the example bilateral filtering techniques described in this disclosure. For instance, filter unit 128 may perform the non-local bilateral (NL-Bil) technique as part of a video encoding process where video encoder 20 reconstructs blocks of video data for storage in DPB 130 for use in inter-prediction.

As shown in FIG. 11, video encoder 20 receives video data and stores the received video data in video data memory 100. Video data memory 100 may store video data to be encoded by the components of video encoder 20. The video data stored in video data memory 100 may be obtained, for example, from video source 18. DPB 130 may be a reference picture memory that stores reference video data for use in encoding video data by video encoder 20, e.g., in intra- or inter-coding modes. Video data memory 100 and DPB 130 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 100 and DPB 130 may be provided by the same memory device or separate memory devices. In various examples, video data memory 100 may be on-chip with other components of video encoder 20, or off-chip relative to those components.

Partitioning unit 102 retrieves the video data from video data memory 100 and partitions the video data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 104 may select one of a plurality of possible coding modes, such as one of a plurality of intra coding modes or one of a plurality of inter coding modes, for the current video block based on error results (e.g., coding rate and the level of distortion). Prediction processing unit 104 may provide the resulting intra- or inter-coded block to summer 112 to generate residual block data and to summer 124 to reconstruct the encoded block for use as a reference picture.

Intra prediction unit 110 within prediction processing unit 104 may perform intra-predictive coding of the current video block relative to one or more neighboring blocks in the same frame or slice as the current block to be coded to provide spatial compression. Motion estimation unit (MEU) 106 and motion compensation unit (MCU) 108 within prediction processing unit 104 perform inter-predictive coding of the current video block relative to one or more predictive blocks in one or more reference pictures to provide temporal compression.

Motion estimation unit 106 may be configured to determine the inter-prediction mode for a video slice according to a predetermined pattern for a video sequence. The predetermined pattern may designate video slices in the sequence as P slices or B slices. Motion estimation unit 106 and motion compensation unit 108 may be highly integrated, but are illustrated separately for conceptual purposes. Motion estimation, performed by motion estimation unit 106, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 130. For example, video encoder 20 may interpolate values of one-quarter pixel positions, one-eighth pixel positions, or other fractional pixel positions of the reference picture. Therefore, motion estimation unit 106 may perform a motion search relative to the full pixel positions and fractional pixel positions and output a motion vector with fractional pixel precision.

Motion estimation unit 106 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 130. Motion estimation unit 106 sends the calculated motion vector to entropy encoding unit 118 and motion compensation unit 108.

Motion compensation, performed by motion compensation unit 108, may involve fetching or generating the predictive block based on the motion vector determined by motion estimation, possibly performing interpolations to sub-pixel precision. Upon receiving the motion vector for the PU of the current video block, motion compensation unit 108 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 112 represents the component or components that perform this subtraction operation. Motion compensation unit 108 may also generate syntax elements associated with the video blocks and the video slice for use by video decoder 30 in decoding the video blocks of the video slice.

After prediction processing unit 104 generates the predictive block for the current video block, either via intra prediction or inter prediction, video encoder 20 forms a residual video block by subtracting the predictive block from the current video block. The residual video data in the residual block may be included in one or more TUs and applied to transform processing unit 114. Transform processing unit 114 transforms the residual video data into residual transform coefficients using a transform, such as a discrete cosine transform (DCT) or a conceptually similar transform. Transform processing unit 114 may convert the residual video data from a pixel domain to a transform domain, such as a frequency domain.

Transform processing unit 114 may send the resulting transform coefficients to quantization unit 116. Quantization unit 116 quantizes the transform coefficients to further reduce bit rate. The quantization process may reduce the bit depth associated with some or all of the coefficients. The degree of quantization may be modified by adjusting a quantization parameter. In some examples, quantization unit 116 may then perform a scan of the matrix including the quantized transform coefficients. In another example, entropy encoding unit 118 may perform the scan.

Following quantization, entropy encoding unit 118 entropy encodes the quantized transform coefficients. For example, entropy encoding unit 118 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 118, the encoded bitstream may be transmitted to video decoder 30, or archived for later transmission or retrieval by video decoder 30. Entropy encoding unit 118 may also entropy encode the motion vectors and the other syntax elements for the current video slice being coded.

Inverse quantization unit 120 and inverse transform processing unit 122 apply inverse quantization and inverse transformation, respectively, to reconstruct the residual block in the pixel domain for later use as a reference block of a reference picture. Motion compensation unit 108 may calculate a reference block by adding the residual block to a predictive block of one of the reference pictures within one of the reference picture lists. Motion compensation unit 108 may also apply one or more interpolation filters to the reconstructed residual block to calculate sub-integer pixel values for use in motion estimation. Summer 124 adds the reconstructed residual block to the motion compensated prediction block produced by motion compensation unit 108 to produce a reconstructed block.

Filter unit 128 filters the reconstructed block (e.g. the output of summer 124) and stores the filtered reconstructed block in DPB 130 for use as a reference block. The reference block may be used by motion estimation unit 106 and motion compensation unit 108 as a reference block to inter-predict a block in a subsequent video frame or picture. Filter unit 128 may perform any type of filtering such as deblock filtering, SAO filtering, peak SAO filtering, ALF, and/or GALF, and/or other types of loop filters, including the techniques described in this disclosure. A deblock filter may, for example, apply deblocking filtering to filter block boundaries to remove blockiness artifacts from reconstructed video. A peak SAO filter may apply offsets to reconstructed pixel values in order to improve overall coding quality. Additional loop filters (in loop or post loop) may also be used.

As described above, filter unit 128 may be configured to perform the example techniques described in this disclosure. For example, filter unit 128 may be configured to perform non-local bilateral filtering (NL-Bil) technique to filter a current sample and generate a filtered current sample of a block of the video data. To perform the NL-Bil technique, filter unit 128 may be configured to determine a difference between sample values of a first window covering the current sample and a second window covering a neighboring sample. Each of the first and second windows include two or more samples. Filter unit 128 may determine a weighting parameter associated with the current sample based on the determined difference, and filter the current sample based on the determined weighting parameter to generate the filtered current sample. Filter unit 128 may output the filtered current sample (e.g., to DPB 130).

As described above, the difference may be between intensity values (e.g., luma values) of the sample values (but chroma values are also possible). The first window and the second window may each cover several spatially neighboring samples (e.g., as illustrated in FIGS. 8 and 10). The first window and the second window may include one or more of the same samples and one or more of different samples. For instance, the first window and the second window both include samples identified as (P0,0, P2,3), (P0,1, P2,4), (P0,2, P2,5), (P0,3, P2,6), (P0,4, P2,7), and (P0,5, P2,8). The first window includes the following samples that are not in the second window: P0,6, P0,7, and P0,8. The second window includes the following samples that are not in the first window: P2,0, P2,1, and P2,2.

In the example of FIG. 10, but not a requirement in all examples, the first window includes the current sample and the neighboring sample, and one or more of a first set of samples (e.g., samples other than P0,4 and P0,1), and the second window includes the current sample and the neighboring sample, and one or more of a second set of samples (e.g., samples other P2,4 and P2,7). In this example, at least one sample in the first set of samples is not included in the second set of samples.

Although the above example is described with respect to the first window and the second window being in the same picture, the examples are not so limited. In some examples, the second window covers one or more samples in a different picture than the first window. In such examples, the one or more samples in the different picture are indicated by a given motion vector.

In the above examples, the current sample and the neighboring sample are located in the center in respective first and second windows, but the example techniques are not so limited. Also, the first window and the second window are described as being 3×3 or 5×3. In some examples, filter unit 128 may determine the size of the of the first and second window based on one or more of block size, coordinate of current sample relative to current block, slice, tile, or picture, or whether a current sample is located at picture, slice, or tile boundary.

Filter unit 128 may utilize various techniques to determine the difference between the first window covering the current sample and the second window covering the neighboring sample. In some examples, filter unit 128 may determine the difference in sample values between corresponding samples in the first and second windows. The corresponding samples may be samples located in the same relative locations within the first window and the second window. For instance, corresponding samples, in FIG. 10, are P2,0 and P0,0, P2,1 and P0,1, P2,2 and P0,2, P2,3 and P0,3, P2,4 and P04, P2,5 and P0,5, P2,6 and P06, P2,7 and P0,7, and P2,8 and P0,8. Based on the difference values, filter unit 128 may determine a value for the variable X, which is an input to determine the weighting parameter (e.g., the variable X is an input to determine Rang, from which the weighting parameter is determined).

The following are examples of operations that filter unit 128 may perform determine the value of the variable X used as an input to determine the weighting parameter. Filter unit 128 may determine average absolute intensity differences of corresponding samples of the first and second windows. Filter unit 128 may determine average weighted absolute intensity differences of corresponding samples of the first and second windows. Filter unit 128 may determine a root of average of square intensity differences of corresponding samples of the first and second windows. Filter unit 128 may determine a power of 1/α of an average of absolute intensity differences of corresponding samples raise to the power by a in the first and second windows. Filter unit 128 may determine a root of average of weighted square intensity differences of corresponding samples in the first and second windows.

FIG. 12 is a block diagram illustrating an example video decoder 30 that may implement the techniques described in this disclosure. Video decoder 30 of FIG. 12 may, for example, be configured to receive the signaling described above with respect to video encoder 20 of FIG. 11. In the example of FIG. 12, video decoder 30 includes various circuitry such as programmable circuitry and/or fixed-function circuitry. The example operations of video decoder 30 may be performed by the programmable circuitry, fixed-function circuity, or a combination. The units illustrated in FIG. 12 may be individual circuits or a combination of the units may form a circuit.

In the example of FIG. 12, video decoder 30 includes video data memory 200, entropy decoding unit 202, prediction processing unit 204, inverse quantization unit 210, inverse transform processing unit 212, summer 214, filter unit 216, and DPB 218. Prediction processing unit 204 includes motion compensation unit (MCU) 206 and intra prediction processing unit 208. Video decoder 30 may, in some examples, perform a decoding pass generally reciprocal to the encoding pass described with respect to video encoder 20 from FIG. 11.

During the decoding process, video decoder 30 receives an encoded video bitstream that represents video blocks of an encoded video slice and associated syntax elements from video encoder 20. Video decoder 30 stores the received encoded video bitstream in video data memory 200. Video data memory 200 may store video data, such as an encoded video bitstream, to be decoded by the components of video decoder 30. The video data stored in video data memory 200 may be obtained, for example, via link 16, from storage device 26, or from a local video source, such as a camera, or by accessing physical data storage media.

Video data memory 200 may form a coded picture buffer (CPB) that stores encoded video data from an encoded video bitstream. DPB 218 may be a reference picture memory that stores reference video data for use in decoding video data by video decoder 30, e.g., in intra- or inter-coding modes. Video data memory 200 and DPB 218 may be formed by any of a variety of memory devices, such as DRAM, SDRAM, MRAM, RRAM, or other types of memory devices. Video data memory 200 and DPB 218 may be provided by the same memory device or separate memory devices. In various examples, video data memory 200 may be on-chip with other components of video decoder 30, or off-chip relative to those components.

Entropy decoding unit 202 of video decoder 30 entropy decodes the video data stored in video data memory 200 to generate quantized coefficients, motion vectors, and other syntax elements. Entropy decoding unit 202 forwards the motion vectors and other syntax elements to prediction processing unit 204. Video decoder 30 may receive the syntax elements at the video slice level and/or the video block level.

When the video slice is coded as an intra-coded (I) slice, intra prediction processing unit 208 of prediction processing unit 204 may generate prediction data for a video block of the current video slice based on a signaled intra prediction mode and data from previously decoded blocks of the current frame or picture. When the video frame is coded as an inter-coded slice (e.g., B slice or P slice), motion compensation unit 206 of prediction processing unit 204 produces predictive blocks for a video block of the current video slice based on the motion vectors and other syntax elements received from entropy decoding unit 202. The predictive blocks may be produced from one of the reference pictures within one of the reference picture lists. Video decoder 30 may construct the reference frame lists, List 0 and List 1, using default construction techniques based on reference pictures stored in DPB 218.

Motion compensation unit 206 determines prediction information for a video block of the current video slice by parsing the motion vectors and other syntax elements, and uses the prediction information to produce the predictive blocks for the current video block being decoded. For example, motion compensation unit 206 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 206 may also perform interpolation based on interpolation filters. Motion compensation unit 206 may use interpolation filters as used by video encoder 20 during encoding of the video blocks to calculate interpolated values for sub-integer pixels of reference blocks. In this case, motion compensation unit 206 may determine the interpolation filters used by video encoder 20 from the received syntax elements and use the interpolation filters to produce predictive blocks.

Inverse quantization unit 210 inverse quantizes, i.e., de-quantizes, the quantized transform coefficients provided in the bitstream and decoded by entropy decoding unit 202. The inverse quantization process may include use of a quantization parameter calculated by video encoder 20 for each video block in the video slice to determine a degree of quantization and, likewise, a degree of inverse quantization that should be applied. Inverse transform processing unit 212 applies an inverse transform, e.g., an inverse DCT, an inverse integer transform, or a conceptually similar inverse transform process, to the transform coefficients in order to produce residual blocks in the pixel domain.

After prediction processing unit 204 generates the predictive block for the current video block using, for example, intra or inter prediction, video decoder 30 forms a reconstructed video block by summing the residual blocks from inverse transform processing unit 212 with the corresponding predictive blocks generated by MCU 206 or intra prediction processing unit 208. Summer 214 represents the component or components that perform this summation operation.

Filter unit 216 filters the reconstructed block (e.g. the output of summer 214) and stores the filtered reconstructed block in DPB 218 for use as a reference block. The reference block may be used by motion compensation unit 206 as a reference block to inter-predict a block in a subsequent video frame or picture. Filter unit 216 may perform any type of filtering such as deblock filtering, SAO filtering, SAO filtering, ALF, and/or GALF, bilateral filtering, and/or other types of loop filters, including the techniques described in this disclosure. A deblock filter may, for example, apply deblocking filtering to filter block boundaries to remove blockiness artifacts from reconstructed video. An SAO filter may apply offsets to reconstructed pixel values in order to improve overall coding quality. Additional loop filters (in loop or post loop) may also be used.

The decoded video blocks in a given frame or picture are then stored in DPB 218, which stores reference pictures used for subsequent motion compensation. DPB 218 may be part of or separate from additional memory that stores decoded video for later presentation on a display device, such as display device 32 of FIG. 1.

Filter unit 216 may be configured to perform the example techniques described in this disclosure. For example, filter unit 216 may be configured to perform non-local bilateral filtering (NL-Bil) technique to filter a current sample and generate a filtered current sample of a block of the video data. To perform the NL-Bil technique, filter unit 216 may be configured to determine a difference between sample values of a first window covering the current sample and a second window covering a neighboring sample. Each of the first and second windows include two or more samples. Filter unit 216 may determine a weighting parameter associated with the current sample based on the determined difference, and filter the current sample based on the determined weighting parameter to generate the filtered current sample. Filter unit 216 may output the filtered current sample (e.g., to DPB 218 and/or out for display as decoded video).

As described above, the difference may be based on intensity values (e.g., luma values) of the samples in the first and second windows (but chroma values are also possible). The first window and the second window may each cover several spatially neighboring samples (e.g., as illustrated in FIGS. 8 and 10). The first window and the second window may include one or more of the same samples and one or more of different samples. For instance, the first window and the second window both include samples identified as (P0,0, P2,3), (P0,1, P2,4), (P0,2, P2,5), (P0,3, P2,6), (P0,4, P2,7), and (P0,5, P2,8). The first window includes the following samples that are not in the second window: P0,6, P0,7, and P0,8. The second window includes the following samples that are not in the first window: P2,0, P2,1, and P2,2.

In the example of FIG. 10, but not a requirement in all examples, the first window includes the current sample and the neighboring sample, and one or more of a first set of samples (e.g., samples other than P0,4 and P0,1), and the second window includes the current sample and the neighboring sample, and one or more of a second set of samples (e.g., samples other P2,4 and P2,7). In this example, at least one sample in the first set of samples is not included in the second set of samples.

Although the above example is described with respect to the first window and the second window being in the same picture, the examples are not so limited. In some examples, the second window covers one or more samples in a different picture than the first window. In such examples, the one or more samples in the different picture are indicated by a given motion vector.

In the above examples, the current sample and the neighboring sample are located in the center in respective first and second windows, but the example techniques are not so limited. Also, the first window and the second window are described as being 3×3 or 5×3. In some examples, filter unit 216 may determine the size of the of the first and second window based on one or more of block size, coordinate of current sample relative to current block, slice, tile, or picture, or whether a current sample is located at picture, slice, or tile boundary.

Filter unit 216 may utilize various techniques to determine the difference between the first window covering the current sample and the second window covering the neighboring sample. In some examples, filter unit 216 may determine the difference in sample values between corresponding samples in the first and second windows. The corresponding samples may be samples located in the same relative locations within the first window and the second window. For instance, corresponding samples, in FIG. 10, are P2,0 and P0,0, P2,1 and P0,1, P2,2 and P0,2, P2,3 and P0,3, P2,4 and P04, P2,5 and P0,5, P2,6 and P06, P2,7 and P0,7, and P2,8 and P0,8. Based on the difference values, filter unit 216 may determine a value for the variable X, which is an input to determine the weighting parameter (e.g., the variable X is an input to determine Rang, from which the weighting parameter is determined).

The following are examples of operations that filter unit 216 may perform determine the value of the variable X used as an input to determine the weighting parameter. In one example, filter unit 216 may determine an average absolute intensity differences of corresponding samples of the first and second windows. In one example, filter unit 216 may determine an average weighted absolute intensity differences of corresponding samples of the first and second windows. In one example, filter unit 216 may determine a root average of square intensity differences of corresponding samples of the first and second windows. In one example, filter unit 216 may determine a power of 1/α of average of absolute intensity differences of corresponding samples raise to the power by a in the first and second windows. In one example, filter unit 216 may determine a root of average of weighted square intensity differences of corresponding samples in the first and second windows. These example techniques of filter unit 216 may be performed together or separately.

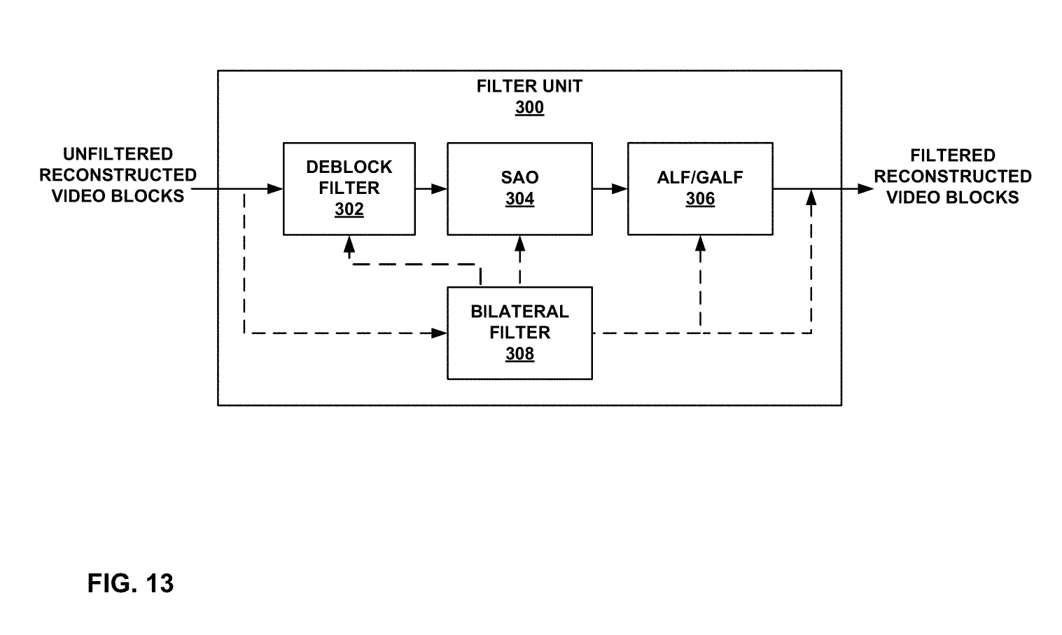

FIG. 13 shows an example implementation of a filter unit 300. Examples of filter unit 300 include filter unit 216 of FIG. 12 or filter unit 128 of FIG. 11. Filter unit 300 may perform the techniques of this disclosure, possibly in conjunction with other components of video encoder 20 or video decoder 30. In the example of FIG. 13, filter unit 300 includes deblock filter 302, SAO filter 304, and ALF/GLAF 306, e.g., as implemented in JEM 6 or JEM 7. Filter unit 300 also includes bilateral filter 308, which may be configured to perform the example non-local bilateral filtering techniques (e.g., NL-Bil) and/or techniques that include non-local division-free bilateral filtering techniques (e.g., NLDV-Bil). As shown in the example of FIG. 13, bilateral filter 308 may be used either separately from deblock filter 302, SAO filter 304, and/or ALF/GLAF 306, or in conjunction with deblock filter 302, SAO filter 304, and/or ALF/GLAF 306. In alternate implementations, filter unit 300 may include fewer filters and/or may include additional filters than those shown in FIG. 13. Additionally or alternatively, the particular filters shown in FIG. 13 may be implemented in a different order than shown in FIG. 13.

In FIG. 13, the dashed lines are used to indicate optional interconnections of the filter blocks. For instance, bilateral filter 308 may receive unfiltered reconstructed video blocks. Bilateral filter 308 may output the filtered video blocks to deblock filter 302, SAO filter 304 an/or ALF/GALF 306, and/or may generate the filtered reconstructed video blocks output by filter unit 300. Although not explicitly shown, in some examples, bilateral filter 308 may receive the filtered block output from deblock filter 302, SAO filter 304, or ALF/GALF 306 and perform further filtering to generate the filtered reconstructed video blocks output by filter unit 300 or for further filtering by other ones of the filters.

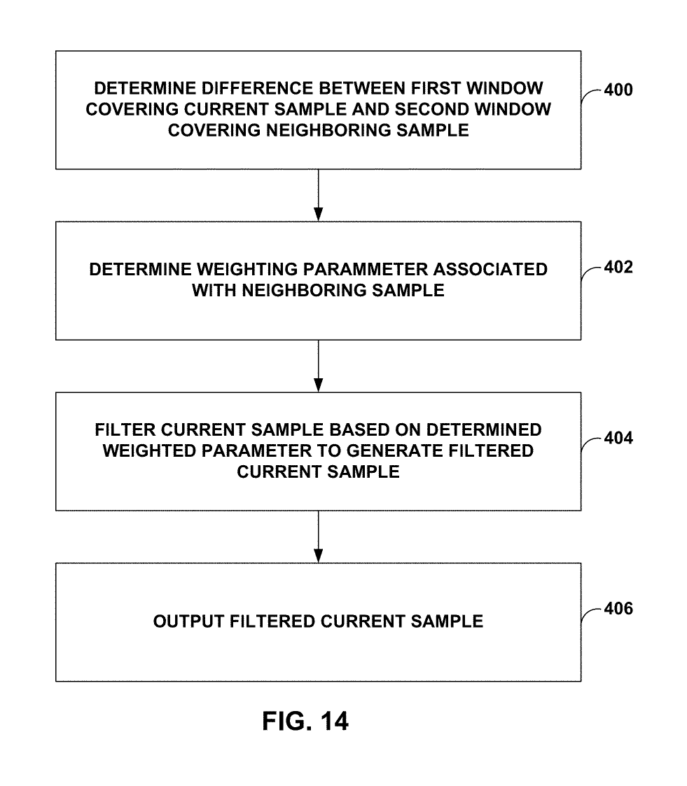

FIG. 14 is a flowchart illustrating one or more example methods of filtering, in accordance with one or more example techniques of this disclosure. The example of FIG. 14 is described with respect to a video coder. Examples of the video coder include video encoder 20 and video decoder 30.

For example, a device (e.g., source device 12 or destination device 14) or circuitry that includes video encoder 20 or circuitry that includes video decoder 30 may include video data memory (e.g., video data memory 100 of FIG. 11 or video data memory 200 of FIG. 12). The video data memory may store video data such as sample values of neighboring samples and sample values of a current sample. Circuitry (e.g., at least one of programmable or fixed-function circuitry) of the video coder may be coupled to the video data memory (e.g., filter unit 128 may be coupled to video data memory 100 and filter unit 216 may be coupled to video data memory 200).

The video coder (e.g., via the circuitry of the video coder, such as filter unit 128 or filter unit 216) may be configured to perform one or more example non-local bilateral filtering (NL-Bil) techniques, including non-local division-free bilateral filtering (NLDV-Bil) techniques, to filter a current sample and generate a filtered current sample of a block of the video data. Accordingly, the video coder may perform the NL-Bil techniques as part of a video encoding process, or the video coder may perform the NL-Bil techniques as part of a video decoding process.

The video coder may determine a difference between sample values of a first window covering the current sample and a second window covering a neighboring sample (400). In this example, each of the first and second windows includes two or more samples. For example, the video coder may determine an intensity (e.g., luma value) difference between the first window and the second window.

As one example, to determine the difference between the first window covering the current sample and the second window covering the neighboring sample, the video coder may be configured to determine, at least in part, a difference in sample values between corresponding samples in the first window and the second window. The corresponding samples include samples located in the same relative locations within the first window and the second window.

For instance, to determine a difference between the first window covering the current sample and the second window covering a neighboring sample, the video coder may be configured to perform, one of or any combination of, determining an average absolute intensity differences of corresponding samples of the first and second windows, determining an average weighted absolute intensity differences of corresponding samples of the first and second windows, determining a root average of square intensity differences of corresponding samples of the first and second windows, determining a power of 1/α of average of absolute intensity differences of corresponding samples raise to the power by a in the first and second windows, or determining a root of average of weighted square intensity differences of corresponding samples in the first and second windows.

In some examples, the first window covers several spatially neighboring samples of the current sample. For instance, the first window and the second window include one or more of the same samples, and one or more of different samples. As one example, the first window includes the current sample and the neighboring sample, and one or more of a first set of samples, the second window includes the current sample and the neighboring sample, and one or more of a second set of samples, and at least one sample in the first set of samples is not included in the second set of samples.

In some examples, the second window covers one or more samples in a different picture than the first window. The one or more samples may be indicated by a given motion vector. In some examples, the current sample is located in the center of the first window. The video coder may determine a size of the first window and the second window based on one or more of block size, coordinates of the current sample relative to current block, slice, tile, or picture, or whether a current sample is located at picture, slice, or tile boundary.

The video coder may determine a weighting parameter associated with the neighboring sample based on the determined difference (402). As one example, assume that the neighboring sample is a first neighboring sample. Based on the difference values, the video coder may determine a first value for the variable X, and input the value of the variable X into the equation to determine the value of Rang, as described above. The video coder may determine the value of Dis, as described above, and multiply the value of Rang by Dis to determine a first weighting parameter associated with the first neighboring sample.

Accordingly, in one example, to determine the weighting parameter (e.g., first weighting parameter), the video coder may determine a difference between sample values of a first window covering the current sample and a second window covering a neighboring sample, and based on the determined difference, the video coder may determine the value of Rang. Also, the video coder may determine a spatial distance between the neighboring sample and the current sample, and based on the determined spatial distance determine the value of Dis (e.g., determine TempD based on the spatial difference, and determine Dis based on TempD, as described above). The video coder may determine the value of the weighting parameter based on Rang multiplied by Dis. Therefore, to determine the weighting parameter associated with the neighboring sample, the video coder may be configured to determine the weighting parameter associated with the neighboring sample based on the difference in the sample values and based on the determined spatial distance.

The video coder may repeat these example operations for each of the neighboring samples. For instance, for a second neighboring sample, the video coder may determine a second window that covers the second neighboring sample. The first window that includes the current sample may be the same as above, or the video coder may determine a new window that includes the current sample. The video coder may determine a second weighting parameter associated with the second neighboring sample, in a manner similar to that described above with respect to the first neighboring sample.

The video coder may repeat similar operations for a third and a fourth neighboring sample (e.g., repeat these operations for neighboring samples P1, P2, P3, and P4 of FIG. 9; however, other neighboring samples are possible). In such examples, the video coder may have determined first, second, third, and fourth weighting parameters.

The video coder may filter the current sample based on the determined weighed parameter to generate a filtered current sample (404). For example, the video coder may multiply the first weighting parameter by a result of a sample value of the first neighboring sample minus the sample value of the current sample to generate a first weighted value (e.g., first weighted value=first weighting parameter*(sample value of first neighboring sample−the sample value)). The video coder may multiply the second weighting parameter by a result of a sample value of the second neighboring sample minus sample value of the current sample to generate a second weighted value (e.g., second weighted value=second weighting parameter*(sample value of second neighboring sample−the sample value)). The video coder may multiply the third weighting parameter by a result of a sample value of the third neighboring sample minus sample value of the current sample to generate a third weighted value (e.g., third weighted value=third weighting parameter*(sample value of third neighboring sample−the sample value)). The video coder may multiply the fourth weighting parameter by a result of a sample value of the fourth neighboring sample minus sample value of the current sample to generate a fourth weighted value (e.g., fourth weighted value=fourth weighting parameter*(sample value of fourth neighboring sample−the sample value)).

The video coder may sum the first, second, third, and fourth weighted values to generate a summed weighted value. The video coder may sum the sample value of the current sample with the summed weighted value to generate the filtered current sample.

In the above example, four neighboring samples are described. The example techniques may be extended to examples that use more than four neighboring samples or fewer than four neighboring samples. Also, the specific process to perform the bilateral filtering is merely one example, and the techniques can be extended to other example ways in which bilateral filtering is performed.

The video coder may output the filtered current sample (406) produced by operation to generate a filtered current sample (404). As one example, as illustrated in FIG. 13, bilateral filter 308 may output the filtered current sample to any one of the other filtering units (e.g., deblock filter 302, SAO filter 304, or ALF/GALF 306). In some examples, the video coder may output the filtered current sample to DPB 130 (FIG. 11), DPB 218 (FIG. 12) or as decoded video data (FIG. 12).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of filtering video data, the method comprising:
performing non-local bilateral filtering (NL-Bil) to filter a current sample and generate a filtered current sample of a block of the video data, wherein performing the NL-Bil comprises:
determining a difference between sample values of a first window covering the current sample and a second window covering a neighboring sample, wherein each of the first and second windows includes two or more samples;
determining a weighting parameter associated with the neighboring sample based on the determined difference; and
filtering the current sample based on the determined weighting parameter to generate the filtered current sample; and
outputting the filtered current sample.

2. The method of claim 1, wherein determining the difference between sample values comprises determining a difference between intensity values of the sample values of the first window and the second window.

3. The method of claim 1, wherein the first window includes several spatially neighboring samples of the current sample.

4. The method of claim 1, wherein the first window and the second window include one or more same samples, and one or more different samples.

5. The method of claim 1, wherein the first window includes the current sample and the neighboring sample, and one or more of a first set of samples, wherein the second window includes the current sample and the neighboring sample, and one or more of a second set of samples, and wherein at least one sample in the first set of samples is not included in the second set of samples.

6. The method of claim 1, wherein the second window includes one or more samples in a different picture than the first window.

7. The method of claim 6, wherein the second window is indicated by a given motion vector.

8. The method of claim 1, wherein the current sample is located at a center of the first window.

9. The method of claim 1, wherein a size of the first window and the second window is based on one or more of block size, a coordinate of the current sample relative to a current block, a slice, a tile, or a picture, or whether the current sample is located at a picture boundary, a slice boundary, or a tile boundary.

10. The method of claim 1, wherein determining a difference between sample values of the first window covering the current sample and the second window covering the neighboring sample comprises determining, at least in part, a difference in sample values between corresponding samples in the first window and the second window, and wherein corresponding samples comprise samples located in the same relative locations within the first window and the second window.

11. The method of claim 1, wherein determining a difference between sample values of the first window covering the current sample and the second window covering a neighboring sample comprises one of or any combination of:
determining an average of absolute intensity differences of corresponding samples of the first and second windows;
determining an average of weighted absolute intensity differences of corresponding samples of the first and second windows;
determining a root average of square intensity differences of corresponding samples of the first and second windows;
determining a power of 1/α of an average of absolute intensity differences of corresponding samples raised to the power by a in the first and second windows; or
determining a root of average of weighted square intensity differences of corresponding samples in the first and second windows.

12. The method of claim 1, wherein performing the NL-Bil comprises performing the NL-Bil as part of a video decoding process.

13. The method of claim 1, wherein performing the NL-Bil comprises performing the NL-Bil as part of a video encoding process.

14. The method of claim 1, further comprising:
determining a spatial distance between the neighboring sample and the current sample,
wherein determining the weighting parameter associated with the neighboring sample based on the determined difference comprises determining the weighting parameter associated with the neighboring sample based on the determined difference and the determined spatial distance.

15. A device for filtering video data, the device comprising:
video data memory configured to store sample values for a current sample and a neighboring sample; and
a video coder comprising at least one of fixed-function or programmable circuitry and coupled to the video data memory, wherein the video coder is configured to:
perform non-local bilateral filtering (NL-Bil) to filter a current sample and generate a filtered current sample of a block of the video data, wherein to perform the NL-Bil, the video coder is configured to:
determine a difference between sample values of a first window covering the current sample and a second window covering a neighboring sample, wherein each of the first and second windows includes two or more samples;
determine a weighting parameter associated with the neighboring sample based on the determined difference; and
filter the current sample based on the determined weighting parameter to generate the filtered current sample; and
output the filtered current sample.

16. The device of claim 15, wherein to determine the difference between sample values, the video coder is configured to determine a difference between intensity values of the sample values of the first window and the second window.

17. The device of claim 15, wherein the first window includes several spatially neighboring samples of the current sample.

18. The device of claim 15, wherein the first window and the second window include one or more of the same samples, and one or more of different samples.

19. The device of claim 15, wherein the first window includes the current sample and the neighboring sample, and one or more of a first set of samples, wherein the second window includes the current sample and the neighboring sample, and one or more of a second set of samples, and wherein at least one sample in the first set of samples is not included in the second set of samples.

20. The device of claim 15, wherein the second window includes one or more samples in a different picture than the first window.

21. The device of claim 20, wherein the second window is indicated by a given motion vector.

22. The device of claim 15, wherein the current sample is located in the center of the first window.

23. The device of claim 15, wherein a size of the first window and the second window is based on one or more of block size, a coordinate of the current sample relative to a current block, a slice, a tile, or a picture, or whether the current sample is located at a picture boundary, a slice boundary, or a tile boundary.

24. The device of claim 15, wherein to determine between sample values of the first window covering the current sample and the second window covering the neighboring sample, the video coder is configured to determine, at least in part, a difference in sample values between corresponding samples in the first window and the second window, wherein corresponding samples comprise samples located in the same relative locations within the first window and the second window.

25. The device of claim 15, wherein to determine a difference between sample values of the first window covering the current sample and the second window covering a neighboring sample, the video coder is configured to one of or any combination of:
determine an average of absolute intensity differences of corresponding samples of the first and second windows;
determine an average of weighted absolute intensity differences of corresponding samples of the first and second windows;
determine a root of average of square intensity differences of corresponding samples of the first and second windows;
determine a power of 1/α of average of absolute intensity differences of corresponding samples raised to the power by a in the first and second windows; or
determine a root of average of weighted square intensity differences of corresponding samples in the first and second windows.

26. The device of claim 15, wherein the video coder comprises a video decoder, and wherein to perform the NL-Bil, the video decoder is configured to perform the NL-Bil as part of a video decoding process.

27. The device of claim 15, wherein the video coder comprises a video encoder, and wherein to perform the NL-Bil, the video encoder is configured to perform the NL-Bil as part of a video encoding process.

28. The device of claim 15, wherein the video coder is configured to:
determine a spatial distance between the neighboring sample and the current sample,
wherein to determine the weighting parameter associated with the neighboring sample based on the determined difference, the video coder is configured to determine the weighting parameter associated with the neighboring sample based on the determined difference and the determined spatial distance.

29. A device for filtering video data, the device comprising:
means for performing non-local bilateral filtering (NL-Bil) to filter a current sample and generate a filtered current sample of a block of the video data, wherein the means for performing the NL-Bil comprises:
means for determining a difference between sample values of a first window covering the current sample and a second window covering a neighboring sample, wherein each of the first and second windows includes two or more samples;
means for determining a weighting parameter associated with the neighboring sample based on the determined difference; and
means for filtering the current sample based on the determined weighting parameter to generate the filtered current sample; and
means for outputting the filtered current sample.

30. A computer-readable storage medium storing instructions that when executed cause one or more processors of a device for filtering video data to:
perform non-local bilateral filtering (NL-Bil) to filter a current sample and generate a filtered current sample of a block of the video data, wherein the instructions that cause the one or more processors to perform the NL-Bil comprise instructions that cause the one or more processors to:
determine a difference between sample values of a first window covering the current sample and a second window covering a neighboring sample, wherein each of the first and second windows includes two or more samples;
determine a weighting parameter associated with the neighboring sample based on the determined difference; and
filter the current sample based on the determined weighting parameter to generate the filtered current sample; and
output the filtered current sample.
